(19) United States
(12) Patent Application Publication
(10) Pub. No.: US 2007/0299617 A1
(43) Pub. Date: Dec. 27, 2007

(54) BIOFOULING SELF-COMPENSATING BIOSENSOR

(76) Inventor: John P. Willis, Buskirk, NY (US)

Correspondence Address: Michael F. Hoffman, 14th Floor, 75 State Street, Albany, NY, 12207, US

(21) Appl. No.: 11/768,284

(22) Filed: Jun. 26, 2007

Related U.S. Application Data
(60) Provisional application No. 60/816,608, filed on Jun. 27, 2006.

(51) Int. Cl. G01N 27/49

(52) U.S. Cl. 702/19; 204/403.01

(57) ABSTRACT

An in vivo biosensor disposed upon a subject comprising an electrochemical cell having a plurality of electrodes and a computer-controlled voltage source incorporating a potentiostat that is generative of a poise potential regime, which computer-controlled voltage source is operationally coupled to a computing device that: computes an output current whose magnitude is proportional to an amount of an analyte in a bodily fluid of the subject; and, adjusts the output current for drift due to biofouling at points in time greater than or equal to an induction period; and, outputs the amount of the analyte by transducing the adjusted output current. Methods and algorithms for adjusting the output current for drift due to biofouling are provided.

This application claims priority of co-pending provisional application 60/816,608 filed on Jun. 27, 2006, entitled “Biofouling self-compensating biosensor,” the contents of which are hereby incorporated by reference.

### FIELD OF THE INVENTION

This invention relates to in vivo biosensors generally and more particularly to devices and methods that adjust for the drift in response occasioned by biofouling of in vivo biosensors.

### RELATED ART

All publications and documents mentioned herein are incorporated herein by reference to disclose and describe the methods and/or materials in connection with which the publications or documents are cited.

All references cited herein, including journal articles or abstracts, published or corresponding U.S. or foreign patent applications, issued U.S. or foreign patents, or any other references, are entirely incorporated by reference herein, to disclose and describe the methods and/or materials in connection with which the publications or documents are cited, including all data, tables, figures, and text presented in the cited references. Additionally, the entire contents of the references cited within the references cited herein are also entirely incorporated by reference.

Citation of any references herein is not intended as an admission that the references are pertinent prior art, or considered material to the patentability of any claim of the present application. Any statement as to content or a date of any references is based on the information available to applicant at the time of filing and does not constitute an admission as to the correctness of such a statement. The dates of publication provided may be different from the actual publication dates, which may need to be independently confirmed.

Reference to known method steps, conventional methods steps, known methods or conventional methods is not in any way an admission that any aspect, description or embodiment of the present invention is disclosed, taught or suggested in the relevant art.

### Biosensors

A biosensor is an electrochemical cell having a working electrode that contains a biological material as a sensing element and/or interacts with a bioanalyte to produce a response that manifests itself as a change in a physical quantity, such as, for example, a current, voltage, or resistance. The response of the biosensor is output from the biosensor as a signal carrying information about the change in the physical quantity, which change is generally correlated with the presence of either an analyte or the amount of an analyte, such as, for example, its concentration. A biosensor may be implanted in a subject, such as a mammal or a human, in which case it is referred to as an in vivo biosensor.

### Analytes

An analyte, or bioanalyte in the case of a biological analyte, is a substance sensed and/or measured by a biosensor, such as a chemical compound, a protein, a molecule or an ion. Glucose is an example of a bioanalyte whose concentration is measured by a biosensor.

### Electrochemical Cells and Sensors

Many biosensors exploit the operating principles of an electrochemical cell to measure the quantity of an analyte. An electrochemical cell has at least two electrodes, a sensing or working electrode and a counter or counter-reference electrode, and together, the two electrodes comprise an electrical circuit. Such biosensors may be electrochemical biosensors. An example of an electrochemical biosensor is an amperometric glucose oxidase (“GOx”) biosensor for the measurement of glucose (GOx biosensor). An electrochemical biosensor generally measures the concentration of an analyte dissolved in a diluent that is a conducting medium. For example, the conducting medium may be blood, lymph, serum or interstitial fluid (“ISF”).

Electrochemical biosensors generally comprise a plurality of electrodes immersed in a conducting medium that is held in a vessel. The electrodes of an electrochemical biosensor may be elements of a circuit that includes a power source for generating a voltage and meters such as an ammeter or a voltmeter. Each electrode is generally comprised of a base conducting material. One or more of the electrodes may also have a sensing element, as described below:

### Electrodes of an Electrochemical Cell

The electrodes may be arrayed in a two-electrode configuration consisting of:

(a) a working (sensing) electrode and

(b) a counter or counter-reference electrode;

alternatively, the electrodes may be arrayed in a three-electrode configuration consisting of:

(a) a working (sensing) electrode;

(b) a counter electrode, and

(c) a reference electrode;

alternatively, the electrodes may be arrayed in a multi-electrode configuration consisting of:

(a) one or more working (sensing) electrodes,

(b) one or more counter electrodes, and

(c) one or more reference electrodes.

In some cases, the base conducting material and the sensing element may be integrated on the working electrode; or, the sensing element may be chemically, physically or mechanically bound to the base conducting material of the working electrode by physical entrapment, covalent linking or, adsorption.

### Working Electrode

The working or sensing electrode interacts with an analyte dissolved or suspended in a conducting medium, such as water, blood, plasma, serum, lymph, interstitial fluid and the like. The interaction of the working electrode with an analyte produces a change in voltage, current, charge, impedance, etc., that may be transmitted to a digital or analog measuring device such as an ammeter, voltmeter or electrometer. The means for transducing the response signal of the working electrode into a voltage, current, charge, impedance, concentration, etc. is referred to as a transducing device or monitoring device.

### Reference Electrode

The reference electrode serves as a reference point with respect to which the voltage at the working electrode is measured or applied. When properly incorporated into an electrical circuit containing a potentiostat, the reference electrode allows an exact potential difference to be maintained between itself and the working electrode, by varying the potential difference between the working electrode and the counter electrode.

### Counter Electrode

When a voltage is applied between the working electrode and the counter electrode, the potential may be used to drive an electrochemical reaction at the surface of the working electrode. The output current produced from the electrochemical reaction at the working electrode is balanced by a current flowing in the opposite direction at the counter electrode. The sensor output current resulting from the electrochemical reaction is amplified and may be converted to a voltage in order to display the output signal or a transduced output signal on a recording device. Accordingly, the potentiostat provides the driving input signal to the electrochemical cell and the working electrode provides the output measurement signal from the electrochemical cell.

### Barrier Membrane

If one or more of the components of a biosensor are cytotoxic or immunogenic, the placement of a membrane over the biosensor may prevent adverse reactions with body fluids, tissue and cells. The membrane may be made of a porous material, such as, for example, an encapsulating polymer that provides a biocompatible interface to body fluids and tissue. The membrane also prevents migration of chemical species out of the biosensor, such as, for example, enzymes and mediators, or it may prevent the migration of unwanted components within tissue, cells or body fluid into the biosensor active zone, wherein, in either case, they may adversely affect the biosensor's response. The membrane may also serve to limit the diffusion of a target analyte into the biosensor active zone, thus improving the linearity of the biosensor's response, or preventing saturation of the response.

The terms “membrane,” “coating,” “barrier,” “protective barrier,” “diffusion limiting barrier,” “diffusion limiting coating” or “barrier membrane” are generally understood to be synonymous herein.

### Active Zone

That volume of an electrochemical sensor generally occupying the space between the surface of the working electrode and the inner aspect of a barrier membrane is referred to as the sensor's active zone. If no barrier were present, the active zone is defined as the cross sectional area of a layer of solution within close proximity to the working electrode surface. The thickness of the layer is in the range of angstroms (10⁻⁹ cm), usually less than 20 angstroms. For example, the FAD⁺ moieties within GOx are greater than 20 angstroms from the electrode surface such that a mediator is required to turnover the enzyme's reduced prosthetic groups. In the native form of the enzyme, the prosthetic groups are in their highest oxidation state (FAD⁺),

### Amperometric Glucose Oxidase Biosensor

An electrochemical sensor may be active or passive depending on whether an external electromotive force is applied to the working electrode.

An amperometric electrochemical cell or amperometric sensor, is an active electrochemical sensor, and may consist of two or more electrodes and, at least one, comprises a working electrode, having a sensing element on its surface, to which a voltage is applied that can initiate an oxidation-reduction (“redox”) reaction between the sensing element and an analyte in solution (“target analyte”).

Using an amperometric sensor configuration with two or more electrodes, a typical amperometric biosensor may consist of a working electrode (e.g. platinum wire) coated with Glucose Oxidase (GOx) to form the sensing element. The biosensor may also employ a barrier membrane encapsulating one or more electrodes.

FIG. 1 is a graphical depiction of a reaction scheme for the oxidation of glucose, by GOx on a working electrode, within the active zone of an amperometric GOx biosensor. The forward and reverse arrows labeled “mass flux” indicate there is a dynamic mass transfer (mass flux) across the membrane barrier, driven by concentration and ionic gradients between components in the fluid outside the barrier membrane (e.g. glucose and ions), and the analyte and products produced by the enzymatic and/or electrochemical reaction occurring on the inside of the barrier membrane within the active zone near the working electrode surface.

Glucose in solution crosses the barrier membrane where it reacts with GOx to produce gluconolactone and/or gluconic acid. In the process, FAD⁺ prosthetic groups buried within the enzyme are reduced to FADH₂. In order for the enzymatic, catalytic cycle to continue, the reduced FADH₂ must be oxidized to the active form FAD⁺. In order for the reaction to be catalytic, a continuous supply of an oxidant mediator (Mₒₓ), such as oxygen, is required to oxidize FADH₂ to FAD⁺ so the cycle may continue. A transduction event occurs when a current is generated by the oxidation of the reduced mediator at the surface the working electrode. If oxygen is the mediator, the reduced mediator consists of hydrogen peroxide and its oxidation at the surface of the working electrode proceeds as follows:

H₂O₂→2H⁺+O₂+2e⁻ (1)

Or in the case of a metal containing mediator,

M_{red} [symbol] Mₒₓ+e⁻ (2)

In the case of oxygen mediation, platinum working electrode potentials of +0.2 to +0.8 v (relative to a silver-silver chloride reference electrode) drive the electrocatalytic oxidation of hydrogen peroxide to produce a current that is directly proportional to the concentration of glucose, because for each molecule of glucose oxidized, one hydrogen peroxide molecule is produced.

The regeneration of oxygen, by the electro-oxidation of hydrogen peroxide, augments the dissolved oxygen supply and aids in reducing the oxygen dependence of the enzyme reaction. An excess of GOx is used to prevent the enzyme reaction from becoming enzyme limited and to mitigate loss in enzyme activity. Under these conditions, the limiting reagents are glucose and oxygen. In some physiological fluids, the oxygen tension may be so low that oxygen becomes rate limiting and the current saturates at a relatively low glucose concentration.

A barrier membrane may aid in preventing oxygen limitation by reducing the diffusion of glucose across the barrier membrane into the active zone while maintaining or enhancing the diffusion of oxygen. Under these conditions, a GOx biosensor can exhibit a linear response up to relatively high glucose concentrations (e.g. >500 mg/dL).

If a mediator other than oxygen is used, for example, a metallocene such as ferrocene or a metal bipyridine complex such as osmium bipyridine, the transduction event is the oxidation of the reduced metallic ion within the organometallic complex. These types of mediators are low molecular weight compounds that shuttle electrons between the enzyme's internal prosthetic groups and the biosensor working electrode surface. If the electrochemical rate of mediator turnover is faster than that of oxygen, the biosensor may maintain sensitivity at zero oxygen tension.

### In Vitro Biosensor Calibration

When referring to electrochemical biosensors, “calibration” is an operation by which a biosensor response, i.e., a current or integrated current, is measured against various standard reference concentrations of an analyte (“calibrators”) to determine the sensitivity, S, of a biosensor. Knowing S, unknown analyte concentrations may be computed from electrochemical biosensor responses. The analyte concentration for each “calibrator” is in turn measured by a standard reference method, such as a clinical laboratory reference method. In vitro, clinical laboratory reference methods may be optical or electrochemical. One such clinical laboratory reference method for the measurement of glucose concentration employs an amperometric GOx biosensor. A well-known instrument employing an amperometric GOx biosensor is the Yellow Springs Instruments (YSI) Glucose Analyzer.

In the case of an amperometric biosensor, the biosensor response current is directly proportional to analyte concentration and the two parameters, analyte concentration and sensor response current, are related by a simple linear expression:

iₘ=Sₖ[Cₘ]+bₖ (3)

In equation (3), iₘ is the sensor response current (e.g. nA, μA), Sₖ represents the sensitivity, [Cₘ] is the analyte concentration (e.g., glucose) and bₖ is the y-intercept or the sensor response current at zero analyte concentration determined within the same time period as Sₖ, where (k=0, 1, 2, 3 . . . ). The subscript “m” indicates that the analyte concentration [Cₘ] and its biosensor response current iₘ need not correspond to the same time-period within which the calibration yielding bₖ and Sₖ was performed.

By rearranging terms in equation 3, an expression for analyte concentration is obtained:

[Cₘ]=(iₘ−bₖ)/Sₖ (4)

In graphical representations of response vs. analyte concentration, the biosensor response is plotted on the y-axis or ordinate and analyte concentration plotted on the x-axis or abscissa. Each sensitivity Sₖ is expressed as biosensor response per unit of analyte concentration and Sₖ is the slope of the plot of response vs. glucose concentration. For example, Sₖ may be expressed as μA/mg/dL or S/mM. Sensitivity Sₖ can represent a series of sensitivity measurements taken at various time points. When k=0, S₀ represents the initial sensitivity.

In vitro, various concentrations of analyte in aqueous buffer solution are used to calibrate an electrochemical biosensor; and if a constant potential is applied at the working electrode, the y-intercept (bₖ) should be nearly zero at zero analyte concentration. Responses are measured when the biosensor response reaches a plateau after a change in analyte concentration or after an equilibration period. If more than two analyte concentrations are used for calibration, the sensitivity and y-intercept may be determined by linear regression or a least squares method.

### In Vivo Biosensor Calibration

When electrochemical biosensors are used in vivo, there is no simple way to transform in vitro calibration parameters into in vivo calibration parameters. For this reason, prior art in vivo biosensors require calibration and recalibration using blood samples taken from the subject and analyzed using an in vitro method or device other than the in vivo biosensor. For example, a device such as an in vitro blood glucose meter or an in vitro instrument such as the YSI glucose analyzer can be used to calibrate an in vivo amperometric GOx biosensor using one or more samples of the subject's blood at different in vivo blood glucose concentrations.

If a zero y-intercept exists, then the term bₖ=0 and, by equation 3, the sensitivity Sₖ may be determined by a single-point calibration, using a single reference analyte concentration [C_{ref}]k:

Sₖ=iₖ/[C_{ref}]ₖ (5)

The term [C_{ref}]k represents any reference analyte concentration determined by an in vitro blood measurement or a standard laboratory reference method. The use of an in vitro reference measurement allows the use of Sₖ to determine in vivo glucose concentrations.

If a two-point calibration is used, the slope is calculated as follows:

Sₖ=(i₂−i₁)/([C_{ref}]₂−[C_{ref}]₁) (6)

Where [C_{ref}]₂>[C_{ref}]₁ and the terms i₁ and i₂ represent the biosensor response currents for two reference analyte concentrations 1 and 2, respectively. The y-intercept bₖ may be zero, or may have a value determined by linear regression or the value of i₁ in equation 6 when [C_{ref}]₁=0.

A dynamic technique, with the application of a periodic waveform such as a square wave, sinusoidal wave, saw-tooth wave, etc., or a combination of waveforms, may be used to generate periodic changes in the applied voltage or current at the working electrode of a biosensor. The waveform may be DC or AC, and of either negative or positive polarity versus a reference electrode.

### The Problem of Biofouling and Recalibration

An amperometric enzyme biosensor, such as for the measurement of glucose, consumes the analyte in the process of measurement. Because of this, amperometric enzyme biosensors are mass detecting sensors rather than activity/concentration sensors wherein the analyte is not consumed (e.g. ion selective electrodes). Biofouling limits the mass flux of a measurable target analyte into a biosensor's active zone. Accordingly, biofouling of the diffusion limiting membrane adversely affects biosensor accuracy by limiting the mass of analyte within the active zone and therefore the magnitude of the biosensor response. As more biofouling occurs, less analyte enters the active zone, and the signal generated for the same “external” (in the fluid in the outer aspect of the barrier membrane) analyte concentration is less for the biofouled sensor than a non-biofouled biosensor. If the biofouling process is gradual, the sensitivity of the sensor will appear to “drift” with time. The extent of biofouling is variable and not easily measured. For this reason, in vivo biosensors require frequent recalibration.

Frequent recalibration of in vivo biosensors is a time-consuming, inconvenient and expensive action that militates against patient compliance. What is needed is an in vivo biosensor that self-compensates for changes in sensitivity, related to biofouling, thus reducing or eliminating the need for recalibration using blood samples taken from the patient.

### SUMMARY OF THE INVENTION

The present invention relates to devices and methods for adjusting degradations in the sensitivity of in vivo biosensors due to biofouling.

The present invention provides an in vivo biosensor, disposed upon a subject, for a run-time Tr, comprising an electrochemical cell having a plurality of electrodes, a computer-controlled voltage source incorporating a potentiostat generative of a poise potential regime, which programmable voltage source is operationally coupled to at least one computer system, wherein the computer system:

(a) computes an output signal from an in vivo biosensor, in response to a known or unknown analyte concentration within a bodily fluid of the subject;

(b) if drift is detected, an algorithm adjusts the output signal or the sensitivity at points in time greater than an induction period; and, if no drift is detected, no adjustment is made to the output biosensing signal or sensitivity and,

(c) computes the concentration of the analyte by transduction of the output signal.

In a first aspect, the invention provides system for capturing blood glucose readings, comprising: a biosensor having two electrodes, wherein a first electrode can be disposed beneath a skin surface; a waveform generator for generating and applying voltage waveforms across the two electrodes; a sampling system for sampling biosensor output signals from the biosensor in response to an associated applied voltage waveform; and a biofouling analysis system that provides a drift adjustment function; and a blood glucose calculation system that calculates a blood glucose concentration from the drift adjustment function and the biosensor output signal.

In a second aspect, the invention provides computer program product stored on a computer readable medium, which when executed by a computer system, captures blood glucose readings, the computer program product comprising: program code for generating and applying voltage waveforms across two electrodes of a biosensor, wherein a first electrode can be disposed beneath a skin surface; program code for sampling biosensor output signals from the biosensor in response to an associated applied voltage waveform; and program code for calculating a blood glucose concentration from a drift adjustment function and the biosensor output signal.

In a third aspect, the invention provides method for adjusting drift of an in vivo biosensor's output signal comprising the steps of: disposing a biosensor on the skin of a subject, wherein the biosensor includes at least two electrodes, one of which is implanted; activating a biosensor on the skin of a subject by applying a voltage between two electrodes; measuring an output signal from the biosensor; determining whether the output signal is drifting and, if not drifting, computing an in vivo analyte concentration from the output signal and if drifting, computing the in vivo analyte concentration by applying a drift adjustment to the output signal.

The present invention also provides a method of adjusting the output of an in vivo biosensor for drift due to biofouling and a computer program product, comprising a computer usable medium having a computer readable program code embodied therein, wherein the computer readable program code comprises an algorithm adapted to execute the method of adjusting the output signal of an in vivo biosensor for drift due to biofouling, the method comprising the steps of:

(a) disposing the biosensor on the skin of a subject for a run-time that includes an induction period;

(b) storing or computing calibration parameters, such as slope and intercept, determined from factory calibration or from the subject's blood;

(c) applying a poise potential regime, to the working electrode, that generates a constant applied voltage or a varying voltage that results in biosensor response signals, or combination of poise potential regimes from known or unknown, in vivo analyte concentrations;

(d) storing biosensor response signals as a set of unadjusted biosensor response signals;

(e) computing and storing, over a selected run-time period within the baseline period, initial biofouling parameters that are compared to the same parameters computed at run-times greater than an induction period to determine if a biofouling correction is necessary or comparing the initial biofouling parameters to pre-set threshold values for the purpose of determining whether a drift adjustment function should be applied to biosensor response signals at run-times greater than an induction period;

(f) computing comparison functions, such as relative difference functions [RDx]_{Tr}, where x=1, 2, 3, . . . indicates one or a series of relative difference functions; and,

(g) using the above described relative difference functions to compute drift adjustment functions; and,

(h) if a relative difference function [RDx]_{Tr}, computed at run-times greater than an induction period, is outside a threshold limit, computing a real-time, run-time indexed drift adjustment function [Dx]_{Tr}, and adjusting the sensitivity, the biosensor response signal or both, thereby generating drift adjusted biosensor response signals. If no drift is detected no adjustment is made; and,

(i) Transducing the drift-adjusted or non-drift adjusted biosensor response signals into output analyte concentrations.

The present invention:

(a) sustains the accuracy and precision of in vivo biosensors for greater periods;

(b) decreases the frequency with which in vivo biosensors must be recalibrated;

(c) decreases the burden on human subjects of using in vivo biosensors; and,

(d) improves patient compliance with the use of in vivo biosensors.

### Additional aspects of the present invention will be apparent in view of the description that follows.

### BRIEF DESCRIPTION OF THE FIGURES

FIG. 1 shows a graphical representation of the catalytic reaction scheme between glucose, GOx and a mediator within the active zone of an amperometric GOx biosensor.

FIG. 2 depicts an example of the relationship between the run-time, equilibration period, baseline period and the induction period.

FIG. 3 illustrates a graph of a biosensing current as a function of time following the application of a poise voltage to an in vitro amperometric biosensor when the analyte concentration is zero.

FIG. 4A is a schematic representation of a first illustrative biosensor configuration.

FIG. 4B is a schematic representation of a second illustrative biosensor configuration.

FIG. 4C is a schematic representation of a third illustrative biosensor configuration.

FIG. 4D is a schematic representation of a fourth illustrative biosensor configuration.

FIG. 4E is a schematic representation of a fifth illustrative biosensor configuration.

FIG. 5 shows a graph of the behavior of the poise potential established between a working electrode and reference electrode of a biosensor in response to a voltage pulse.

FIG. 6 shows a graph of the effect of increasing electrical resistance Rₛ on biosensing current transients resulting from a square-wave poise voltage pulse applied between a working electrode and a counter electrode of a biosensor.

FIG. 7 shows a graph of a series of square-wave voltage pulses, each having a defined pulse width period τ₁, an interpulse period τ₂ and current transients, [i(t)]ₙ, resulting from its application to the working electrode of a 3-electrode electrochemical cell.

FIG. 8 shows a more detailed view of one of the biosensing current transients appearing in response to a square-wave voltage pulse shown in FIG. 7.

FIG. 9 shows a graph of the natural logarithm of transient currents plotted against transient time.

FIG. 10 shows a graph of a biosensor's current response, versus run-time Tr, for each of two discretely sampled transient currents from n current transients obtained by periodic pulsing of the voltage across an in vivo working electrode and a counter electrode of an amperometric GOx biosensor for a run-time period of 450 minutes.

FIG. 11 shows a graph of measured values of a non-linear difference function, [RD1]_{Tr}, obtained from two sampled transient currents (from the graph shown in FIG. 10) indexed to run-time, Tr.

FIG. 12 shows a graph of measured values of a non-linear difference function [RD1]_{Tr} multiplied by its corresponding run-time to yield a measured, linearized relative difference function, Tr[RD1]_{Tr}, and a calculated line obtained by linear regression of the measured linearized difference function versus run-time within a baseline period. The slope of the regression line is shown as m_{Tr}=0.240 and the y-intercept is −0.885.

FIG. 13 shows a graph of the measured values of the difference function from FIG. 11 and the calculated values of the difference function, [RD1]_{Tr}, obtained by dividing each value of the calculated, linearized difference function values of FIG. 12, calculated according to equation 31, by their corresponding run-time values.

FIG. 14 shows graphs used in the calculation of two gain adjustment functions G1 and G2.

FIG. 15 shows graphical representations of hypothetical current transients for drifting and non-drifting in vivo biosensor responses.

FIG. 16 shows two graphs of Tr[RD1]_{Tr} as a function of run-time for a drifting and non-drifting biosensor output signal. In FIG. 16, the ordinate is labeled “Tr[RD1]_{Tr}” and the abscissa is labeled “Tr, min”. The upper graph in FIG. 16, shows the calculated and measured values of Tr[RD1]_{Tr} for a non-drifting biosensor having a slope m_{Tr}, measured within a baseline period, equal to 0.347. The lower graph in FIG. 16, shows the calculated and measured values of Tr[RD1]_{Tr} for a drifting biosensor having a slope m_{Tr}, measured within a baseline period, equal to 0.240.

FIG. 17 shows graphs of the difference in the gain adjustment functions [G2]_{Tr} and [G1]_{Tr} as a function of run-time, for a drifting and a non-drifting biosensor. The ordinate is labeled “[G2−G1]_{Tr}” and the abscissa is labeled “Tr, min”.

FIG. 18 shows that the average of the gain adjustment functions [G1]_{Tr} and [G2]_{Tr}, denoted as [D1]_{Tr}, at each run-time point greater than an induction period, is a non-linear function of run-time. The ordinate is labeled “[(G1+G2)/2]_{Tr} and the abscissa is labeled “Tr, min”. The graph is further labeled with [D1]_{Tr}=[(G1+G2)/2]_{Tr}

FIG. 19 shows a graph of unadjusted glucose values, measured by a drifting intradermal glucose biosensor, as a function of run-time, plotted against reference glucose values, obtained by fingerstick measurements, as a function of run-time. The left ordinate is labeled “ref glu mg/dL”, the right ordinate is labeled “meas glu mg/dL” and the abscissa is labeled “Tr, min”. Open circles represent fingerstick glucose values measured at various run-times and the black solid line represent measured or calculated values of glucose at each run-time point, Tr.

FIG. 20 shows a graph of unadjusted biosensing response currents plotted against reference blood glucose values for the drifting in vivo biosensor response shown in FIG. 19. The linear regression line was determined from fingerstick glucose measurements and sensor response currents taken within a baseline period.

FIG. 21 shows a graph of the variation in the % error of the calculated glucose values versus reference glucose values for the drifting biosensor response shown in FIG. 19 as a function of time, Tr.

FIG. 22 shows the effect of the application of [D1]_{Tr} on the drifting biosensing response as reflected in glucose values calculated from the drift adjusted biosensing responses.

FIG. 23 shows [D1]_{Tr} adjusted biosensor responses plotted against all reference blood glucose values from FIG. 20, along with a linear regression line using glucose fingerstick reference data over the entire run-time period.

FIG. 24 depicts a scheme for processing the biosensor signal responses, adjusting the biosensor signal response for drift, if detected, and transducing the adjusted or unadjusted biosensor signal responses to analyte concentrations.

FIG. 25 depicts a flow chart describing the various steps used to determine whether the biosensor output signal is drifting and the steps followed in calculating a glucose concentration from an unadjusted or adjusted biosensor output signal.

### DETAILED DESCRIPTION OF THE INVENTION

The following detailed description illustrates the invention by way of example, not by way of limitation of the principles of the invention. This description will clearly enable one skilled in the art to make and use the invention, and describes several embodiments, adaptations, variations, alternatives and uses of the invention, including what we presently believe is the best mode of carrying out the invention. It is to be understood that this invention is not limited to the particular embodiments described, as such may, of course, vary.

### Symbols

In general, symbols without a subscript refer to a continuous variable, such as the continuous biosensing current i, the continuous transient time t, or the continuous run-time Tr.

Symbols with the subscript n are discretely sampled variables that correspond or are indexed to a discretely sampled value of the run-time [Tr]ₙ, such as [iₚ]ₙ, a discretely sampled value of the current of an n^{th} biosensing current transient that is indexed to a discretely sampled value of the run-time [Tr]ₙ.

Symbols with both the subscript n and the subscript j are discretely sampled variables that correspond or are indexed to both a discretely sampled value of the run-time [Tr]ₙ and a discretely sampled transient time tⱼ. For example, [iⱼ]_{Tr} or [iⱼ]ₙ is the value of the transient current that is discretely sampled, at a transient time tⱼ of an n^{th} biosensing current transient, indexed to a discretely sampled value of the run-time [Tr]ₙ.

Symbols with a subscript other than n, j or k identify a variable to a particular value, characteristic, property or definition, such as: the use of the subscript Tr to identify a bracketed variable to the run-time, e.g., [RD1]_{Tr}, or to emphasize the dependence of a discretely sampled transient current on the run-time, e.g., [iⱼ]_{Tr}; or, the use of the subscript, t, to identify variables within the transient time of an individual current transient, e.g., [RTₜ]_{Tr}. The meaning of subscripts other than n, j or k will be apparent from the context in which such subscripts are used.

### Definitions

It is to be understood that the terminology used herein is for describing particular embodiments only, and is not intended to be limiting, since the scope of the present invention will be limited only by the appended claims.

As used herein and in the appended claims, the singular indefinite forms “a”, “an”, and the singular definite form, “the”, include plural referents unless the context clearly dictates otherwise. Thus, for example, reference to a current transient includes a plurality of such current transients and reference to an analyte includes reference to one or more analytes and equivalents thereof known to those skilled in the art, and so forth.

As used herein, the term computing system means a system comprising a micro-processor, an input device coupled to the micro-processor, an output device coupled to the micro-processor, and memory devices coupled to the micro-processor. The input device may be, inter alia, a touchpad or a miniature keyboard, etc. The output device may be, inter alia, a printer, a plotter, a computer screen, a wireless data transmitter, a data transmission cable (e.g., a USB cable) etc. The memory devices may be, inter alia, dynamic random access memory (DRAM), or read-only memory (ROM), etc. The memory device includes computer code. The computer code includes drift adjustment functions invented herein. The micro-processor executes the computer code. The memory device includes input data. The input data includes input required by the computer code. The output device displays output from the computer code. Memory devices may be used as a computer usable medium (or a computer readable medium or a program storage device) having a computer readable program code embodied therein and/or having other data stored therein, wherein the computer readable program code comprises the computer code. A computer program product (or, alternatively, an article of manufacture) of the computer system may comprise the computer usable medium or the program storage device. Any configuration of hardware and software, as would be known to a person of ordinary skill in the art, may be utilized to configure the computer system.

As used herein, the term sensitivity (S) is defined as the change in the response of the biosensor per unit change in concentration of an analyte. In the case of a glucose oxidase (“GOx”) amperometric enzyme biosensor, the biosensor response current is directly proportional to the glucose concentration. As indicated, supra, sensitivity S is expressed as the change in biosensor response current per unit of change in concentration, e.g. nA/mg/dL or nA/mM, where mM is an abbreviation for millimolar (millimoles/Liter) or (mmol L⁻¹) and nA is an abbreviation for nanoamps. The sensitivity may be determined by linear regression of the biosensor response current v. analyte concentration. The slope of such a plot is the sensitivity S.

Continuous run-time refers to time points within the period that an in vivo biosensor is operated or implanted in a subject, and is symbolized Tr. In addition, run-time represented as [Tr]ₙ may be measured or sampled discretely instead of continuously. For example, if a series of n square-wave voltage pulses is applied to an electrochemical cell, a point in run-time [Tr]ₙ may be recorded and cross-indexed to the beginning of each voltage step or the beginning of each entrained biosensing current transient that it generates, so that each voltage step or entrained biosensing current transient is associated with an increasing value of the run-time [Tr]ₙ.

Discretely sampled values of the run-time Tr cross-indexed to a specific biosensing current transient, [iⱼ]_{Tr} are symbolized Tr or [Tr]ₙ, (n=1, 2, 3, . . . ). With respect to recurring biosensing current transients, entrained within a series of square wave voltage pulses, if, for example, the total period P_{τ} of each biosensing current transient is 5 seconds, there will be a corresponding run-time point [Tr]ₙ recorded at multiples of 5 seconds. The first value of [Tr]ₙ is at run-time 5 seconds [P_{τ}] and is denoted as [Tr]₁. Following [Tr]₁, the next run-time value [Tr]₂ occurs at 10 seconds, 2(P_{τ}); and, following [Tr]₂, the next run-time value [Tr]₃ occurs at 15 seconds, 3(P_{τ}), etc. In the figures, the continuous run-time points [Tr]ₙ may be denoted as Tr.

The terms Implantation time or implantation period are synonymous with run-time.

Continuous transient time is symbolized with a lower-case t and refers to time points within any biosensing current transient, generated by a periodic voltage waveform.

Discretely sampled transient times tⱼ(j=1, 2, 3, . . . ) are indexed to time points within a current transient and may, in turn, be indexed to any value of a discretely sampled run-time point [iⱼ]_{Tr}.

Biofouling induction period: Although the body's immune system immediately recognizes a foreign body, there is a biofouling induction period before the foreign body response has an adverse impact on the response of an in vivo biosensor. Evidence has shown biofouling begins to affect a biosensor's response within approximately 30-180 minutes post-implantation. The duration of the biofouling induction period is dependent on the size, biocompatibility and the magnitude of the inflammatory response to the in vivo biosensor. The induction period may last for approximately 1-3 hours post implantation. If necessary, drift adjustments may be applied to the biosensing current at times greater than the induction period. The term induction period is synonymous with biofouling induction period, and is symbolized [Tr]_{induction}.

Baseline data collection time: If baseline data is obtained during a time period within the induction period [Tr]_{induction}, it is possible to adjust biosensing currents for the effect of biofouling at run-times greater than the induction period, i.e., Tr>[Tr]_{induction}. For example, a period within which to collect the baseline data (“baseline data collection time” [Tr]_{baseline}) may be between 60 and 180 minutes post-implantation. Any time range within 60 to 180 minutes may be used to measure baseline data (e.g. 60-80 min). The term baseline period is synonymous with baseline data collection period, and is symbolized [Tr]_{baseline}.

Equilibration period, equilibration time, or break-in period: When a biosensor is implanted within a subject or used in vitro within a test cell, a period is required for equilibration of the biosensor's response to the conductive fluid surrounding the implanted biosensor. The period required for the biosensor's response to reach its steady-state value is called the equilibration period [Tr]_{eq}. The term equilibration time or break-in period is synonymous with equilibration period, and is symbolized [Tr]_{eq}.

The induction period is the sum of the equilibration period and

the baseline period.

[Tr]_{induction}=[Tr]_{eq}+[Tr]_{baseline} (7)

FIG. 2, is a graphical representation of the relationship between the run-time, equilibration period, baseline period and the induction period. FIG. 2 shows an example of a horizontal timeline representing a run-time Tr (run-time line) whose endpoints at Tr=0 minutes and Tr=120 minutes span an induction period. A value of the run-time at Tr=60 minutes is also shown. The period from Tr=0 to Tr=60 represents the equilibration period, [Tr]_{eq}. The time between Tr=60 and Tr=120 minutes represents the baseline period, [Tr]_{baseline}. The sum of [Tr]_{eq} and [Tr]_{baseline} is equal to the induction period.

As used herein, the term applied voltage or applied potential refers to a variable or floating electric potential difference between:

(a) a working electrode; and,

(b) a counter electrode of a biosensor, and is represented as E_{wc}.

As used herein, the term poise voltage, poise potential or bias potential refers to a fixed electric potential difference between a working electrode and a reference electrode of a biosensor, and is represented as E_{wr}.

A potentiostat is used to supply a voltage between the working and counter electrodes. By means of a feedback circuit, the potentiostat varies the applied potential E_{wc} to maintain a constant poise potential E_{wr}.

### Biosensor Equilibration Time

As indicated above, when one or more electrodes of an electrochemical biosensor are implanted within a subject or used in vitro within a test cell, a period is required for equilibration of the biosensor's biosensing current to the conductive fluid surrounding the biosensor. The time required for the biosensing current to reach its steady-state value is called the equilibration period [Tr]_{eq} of the biosensor. An equilibration period exists even in the absence of target analyte.

The equilibration time [Tr]_{eq} is a function, inter alia, of the thickness and chemical complexity of the catalytic surface (sensing element) of the working electrode. For example, if the enzyme layer that forms the catalytic surface of the working electrode is relatively thin, the equilibration time [Tr]_{eq} may be less than 30 minutes. If however, the enzyme layer that forms the catalytic surface of the working electrode is relatively thick or covered with non-enzymatic materials, such as polymers or proteins, then the equilibration time [Tr]_{eq} may be greater than 30 minutes, approaching hours. In either case, a high response current is initially observed that decreases over time to a steady state value consistent with the quantity of the target analyte being measured.

The equilibration time [Tr]_{eq} is also a function of the density and thickness of a biosensor's membrane(s). The greater the density or the thicker the membrane(s) encapsulating a biosensor, the longer it may take for the biosensing current to reach equilibrium. When using GOx and oxygen dissolved in an aqueous fluid as a mediator, to prevent oxygen limitation, the barrier membrane is usually dense; consequently, currents in the range of 10-100 nA (nanoamp, 10⁻⁹) are normally observed. The density and thickness of the membrane may also cause a lag by increasing the response time of a biosensor to changes in a target analyte's concentration. If however, a metallo-organic or synthetic mediator is present within the biosensor's active zone, oxygen limitation is of less concern, so that less dense, thinner membranes will decrease the response time and equilibration time.

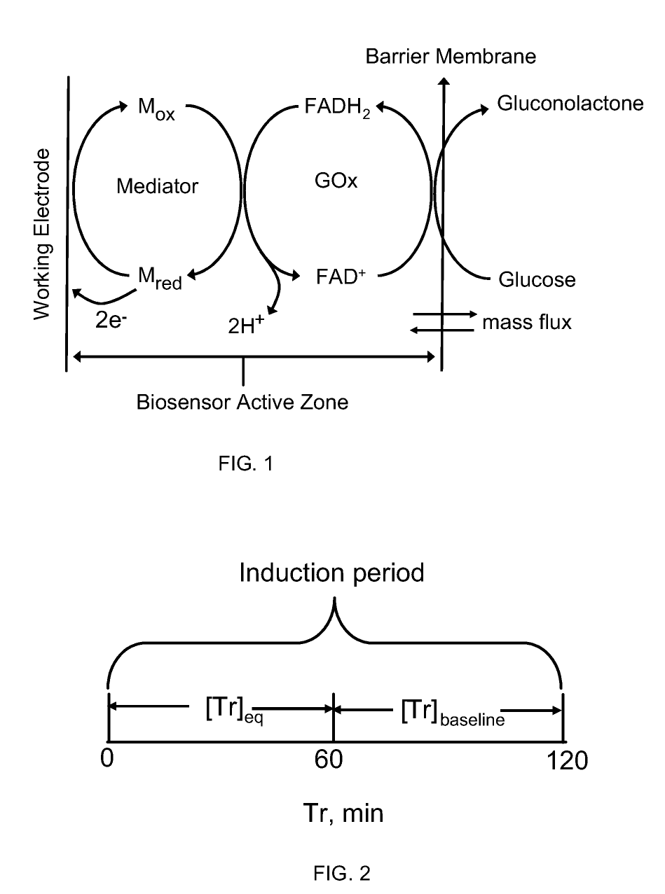

When a steady-state voltage is applied to an in vitro GOx biosensor, the biosensing current, even in the absence of glucose, is initially high and decays to a steady-state value over the course of time comprising the equilibration period. Thereafter, the biosensing current remains at a steady-state value until there is a change in the concentration of a target analyte such as glucose. When glucose is present, the biosensing current will increase due to oxidation of hydrogen peroxide generated by the reaction of GOx with glucose (see FIG. 1).

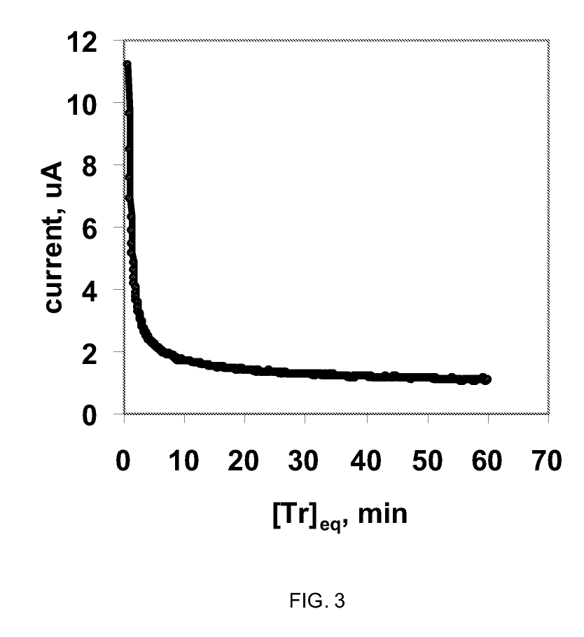

FIG. 3 shows a graph of a biosensing current as a function of run-time following the application of a continuous voltage to an in vitro amperometric biosensor immersed in a conductive aqueous solution without the presence of analyte. In FIG. 3, the ordinate is labeled “current μA and the abscissa is labeled “[Tr]_{eq}, min.” The graph in FIG. 3 shows a biosensing current decay curve over a biosensor equilibration period [Tr]_{eq}.

When an electrochemical biosensor is implanted in vivo, a steady-state may not exist, as shown in FIG. 3, because physiological parameters are dynamic. In vivo, the analyte concentration is never zero; however, there may exist a period of time within which the analyte concentration is relatively constant. However, in vivo analyte concentrations may exhibit significant and rapid changes in concentration so that one is not able to ascertain whether there is an equilibration period as defined in FIG. 3. The output signal due to the equilibration period may be contained within the sensor output signal due to the continual presence of analyte. Rather than waiting an unknown period until the analyte concentration is relatively stable, a fixed equilibration period (e.g. 1-12 hours), a measurement of the rate of change in the signal output or other mathematical method may be utilized to determine when the sensor has “equilibrated” to the fluid surrounding the sensor, even though the level of analyte may be changing.

### Background Response

In the absence of target analyte, the biosensor response over [Tr]_{eq}, is called the “background response” or the “intercept at zero analyte concentration,” or simply, the “intercept.” In aqueous buffer solutions, the intercept should be nearly zero; however, there may be other electroactive species present, called “interferants” that are oxidized or reduced at the same poise potential as the analyte of interest. If a mediator is used, the poise potential may be lowered to the point where interferants are not electrochemically active, resulting in background responses that approach zero. Even in the absence of analyte, a small current flows due to the charging current required to maintain the electrical double layer at the working electrode surface. When implanted in vivo, amperometric biosensing background currents may become significant and must be taken into account when calculating analyte concentrations.

### In Vivo Biosensor Cell Configurations

In configuring a biosensor for in vivo use, the distance between its reference electrode and working electrode should preferably be as small as possible without causing shielding effects. Such placement will reduce the uncompensated resistance Rᵤ between the reference electrode and the working electrode. Additionally, the reference electrode should preferably be small and symmetrically disposed between the working electrode and the counter electrode. The counter electrode should preferably have a surface area larger than the working electrode.

### Observer Sensor

With respect to implanted biosensors, an observer or witness sensor (O) may be used to measure or monitor changes in the physical properties of an in vivo biosensor such as resistance, impedance, conductance, diffusion, pressure, admittance, capacitance, optical, magnetic or other physical property. The observer sensor may be utilized in vivo, close to the implanted biosensor. Changes in electrical, optical, magnetic or other physical property on the surface of an implanted biosensor, may be measured through space by the implanted observer sensor and used to track changes occurring on the surface of the implanted biosensor. The data so obtained, can be correlated with changes in sensitivity of the biosensor. The in vivo, observer sensor may be used independently to measure changes in a physical property of itself that correlates with changes in sensitivity of the implanted biosensor.

Additionally, a combination of an implanted observer sensor and an external or ex vivo observer sensor can be used to measure relative changes in the properties of an implanted observer sensor. In the case of two observer sensors, they may or may not be in direct communication with one another; however, temporal changes in one or more physical properties of the in vivo observer sensor, relative to the ex vivo observer sensor, may be correlated to temporal changes in sensitivity of the in vivo biosensor. In the case of an ex vivo observer sensor, it may be situated in an environment not subject to varying degrees of biofouling. A convenient location for the ex vivo observer sensor is the skin surface of a mammal.

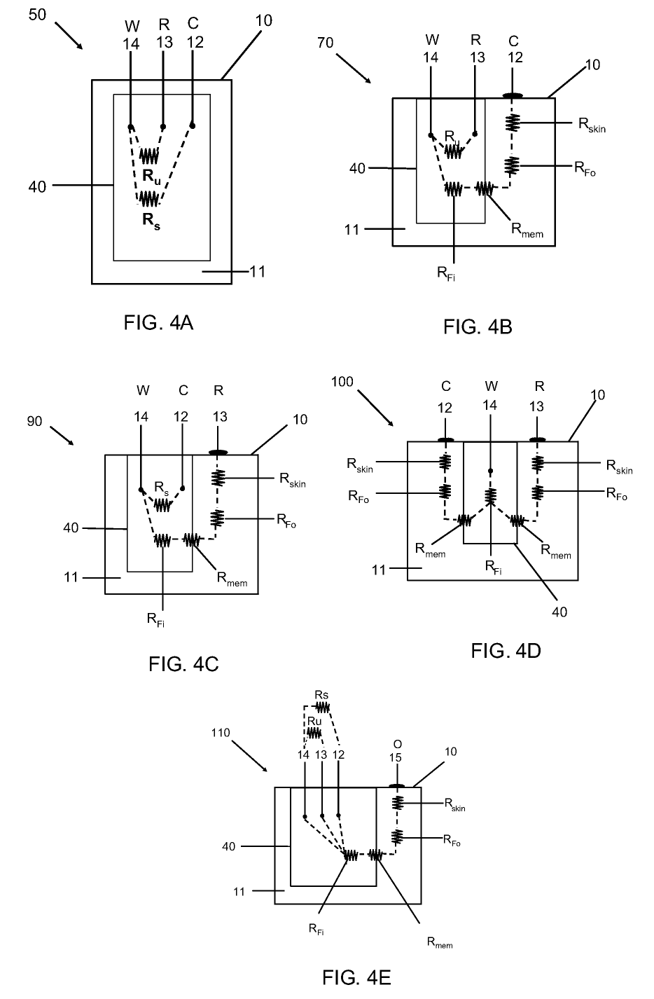

In the descriptions of biosensor configurations that follow, dashed lines interrupted with resistor symbols in accompanying FIGS. 4A-E, represent resistance paths and not hard wires. For example, if a counter electrode resides on a subject's skin, the resistance path to the working electrode includes a contribution of the electrical resistance (or impedance) across the skin and through the underlying tissue to the working electrode.

### First Illustrative Biosensor Configuration

FIG. 4A is a schematic representation of a first illustrative biosensor configuration 50 in which all three of the biosensor's electrodes are implanted within a subject. As shown in FIG. 4A, counter electrode (C), 12, reference electrode (R), 13, and working electrode W, 14, are all implanted within the subject's skin 10 and encapsulated within a barrier membrane 40. In the case of a two-electrode biosensor, reference electrode 13 also serves as a counter electrode and is referred to as a counter-reference electrode.

Implanting all electrodes together is the most optimal configuration; theoretically, for electrochemical sensors and results in the least amount of electrical resistance in the form of the solution resistance between the counter electrode and the working electrode Rₛ and the uncompensated electrical resistance Rᵤ that has been earlier defined to equal the resistance between the working electrode and the reference electrode.

By keeping the reference and counter electrodes close to the working electrode, the magnitude of Rₛ and Rᵤ is minimized.

Within the active zone, the magnitude of Rₛ and Rᵤ are represented as follows:

Rₛ=R_{w}+R_{Fi}+R_{c} (8)

Rᵤ=R_{w}+R_{Fi}+Rᵣ (9)

In Equations 8 and 9, R_{Fi} refers to the electrical resistance of the conductive fluid contained within the active zone of the biosensor and may consist of ISF 11 minus cells and high molecular weight proteins due to their exclusion by a barrier membrane. In FIG. 4A, the electrodes 12, 13 and 14 may be enclosed behind the same membrane 40 or each electrode may be enclosed by a separate membrane (not shown in FIG. 4A). Rᵣ refers to the inherent electrical resistance of the reference electrode 13; and, R_{c} refers to the inherent electrical resistance of the counter electrode 12.

In first illustrative biosensor configuration 50, the magnitude of resistive components Rₛ and Rᵤ are relatively small; and may have a minor IR drop effect on the potential difference Rₛ, between counter, 12 and working electrode 14 or Rᵤ between reference 13 and working electrode 14.

The fluid volume within the active zone of first biosensor configuration 50 is small; and, as the glucose concentration within this fluid volume increases, the resistance components (Rₛ and Rᵤ) may increase because glucose is a neutral molecule. However, in the case of an amperometric GOx biosensor, the products of the chemical and electrochemical processes are charged, so the effect of increasing glucose concentration on the electrical resistance of the fluid, within the active zone, may be minimal.

The drawback to using first illustrative biosensor configuration 50 is that if cells, proteins, fibrin or other cellular materials adhere to the outside surface of a barrier membrane covering a biosensor, there is no convenient way to compensate for the decrease in diffusion or mass transport of a target analyte into the active zone other than by recalibration.

Due to the phenomenon of biofouling, in vivo glucose biosensors of first illustrative biosensor configuration 50 require frequent recalibration using blood samples taken from the subject. The resulting blood glucose value(s) must be manually entered into the in vivo sensor monitor or wirelessly transmitted to the monitor so that new calibration parameters may be calculated. The recalibration process is time consuming, inconvenient and expensive.

### Second Illustrative Biosensor Configuration

FIG. 4B is a schematic representation of a second illustrative biosensor configuration wherein the working electrode and reference electrode are implanted in a subject and the counter electrode contacts the skin of a subject. As shown in FIG. 4B, second illustrative biosensor configuration 70 is defined as a two or three-electrode biosensor wherein:

(a) the counter electrode 12 is in contact with the skin of a subject;

(b) the working electrode 14 is implanted within a subject; and,

(c) the reference electrode 13 is implanted within the subject.

In the case of a two-electrode second illustrative biosensor configuration, reference electrode 13 and counter electrode 12 are the same and together referred to as a reference-counter electrode. Since the counter electrode 12 is outside barrier membrane 40, in a relatively stable environment, it can also serve as an observer sensor (O) and provide a means of indirectly measuring the effect of biofouling, of barrier membrane 40, on working electrode responses.

As in first illustrative biosensor configuration 50, the value of Rᵤ, the resistance between working electrode 14 and reference electrode 13 may be relatively small because reference electrode 13 is close to the working electrode 14. However, Rₛ, the resistance between counter electrode 12 on the skin surface and working electrode 14 may be significant.

The resistive components of Rₛ in the second illustrative biosensor configuration are:
(a) the inherent electrical resistance of the working electrode, R_{w};
(b) the inherent electrical resistance of the counter electrode R_{c};
(c) the electrical resistance across the skin thickness, Rₛₖᵢₙ;
(d) the electrical resistance, R_{Fo}, within the body fluid surrounding the outer aspect of membrane 40;
(e) the electrical resistance, Rₘₑₘ, across membrane 40; and,
(f) the electrical resistance, R_{Fi}, of the body fluid within the active zone.

Rₛ=R_{c}+R_{w}+Rₛₖᵢₙ+R_{Fo}+R_{Fi}+Rₘₑₘ (10)

The inherent resistances of the counter R_{c} and working R_{w} electrodes are constant and the resistance across the skin, Rₛₖᵢₙ, although it may be high (e.g., Kilo-ohms), remains relatively constant once the biosensor has equilibrated, because a conductive, hydrophilic adhesive is used between the skin and counter electrode 12. Once the skin equilibrates with the conductive adhesive, the resistance across the skin stabilizes. The value of Rₛ can be in the meg ohm (10⁶) range.

Owing to homeostasis, the resistance or ionic strength of the fluid surrounding the outer aspect of membrane 40 and defined as R_{Fo} remains relatively constant once the biosensor has equilibrated. Although the resistance of the fluid R_{Fi} within the active zone may vary, it remains low so that its contribution to Rₛ, the resistance between the counter electrode and the working electrode, is relatively small.

The total electrical resistance across the membrane Rₘₑₘ includes R_{mem intrinsic}, the electrical resistance across the inner and outer aspect of membrane 40, and a variable contribution from the electrical resistance of adsorbed protein, cells and fibrinous tissue, R_{biofouling} that may adhere to the outer aspect of membrane 40 during the biofouling process, so that:

Rₘₑₘ=R_{mem intrinsic}+R_{biofouling} (11)

The value of R_{mem intrinsic} during the induction period [Tr]_{induction} of an electrochemical biosensor may be higher than at a later stage because membrane 40 must “wet-up” and establish fluid equilibrium between its inner and outer surfaces. This process contributes to the aforementioned equilibration time [Tr]_{eq} of the electrochemical biosensor, which must transpire before useful measurements can be made. Because most of the terms in equation 10 are either small or relatively constant, the R_{biofouling} term is the variable component and therefore the total resistance Rₛ may be used to track the extent of biofouling.

Following implantation, there are stages to the biofouling process. First, proteins, such as albumin and fibrinogen, adhere to the outside surface of membrane 40, this may be followed by the attachment of different proteins and cell types. As the biosensor's implantation period increases, biofouling may increase, depending on the extent of the inflammatory response to the implanted biosensor. As R_{biofouling} increases, the resultant increase in Rₘₑₘ can produce a significant voltage drop in the applied potential between working electrodes 14 and counter electrode 12.

The voltage drop in the applied potential between working electrode 14 and counter electrode 12 could exceed the compliance voltage (e.g. ±10 volts) of a compensating potentiostat feedback circuit, such that, the biosensor's response saturates; and/or, the fixed poise potential between the working electrode 14 and the reference electrode 13 shifts to a lower value, resulting in a change in the biosensor's response characteristics such as sensitivity and mass transfer across the barrier membrane.

### Third Illustrative Biosensor Configuration

FIG. 4C is a schematic representation of a third illustrative biosensor configuration 90, wherein working electrode 14 and counter electrode 12 are implanted within a subject, and reference electrode 13 contacts the skin surface 10 of a subject. In FIG. 4C, the resistance path between the reference electrode 13 on the skin and the implanted working electrode 14 is shown as a dashed line interrupted with resistor symbols, and its total resistance is designated as Rᵤ. Since reference electrode 13 is outside membrane 40, in a relatively stable environment, it can also serve as an observer sensor (O) and provide a means of indirectly measuring the effect of biofouling on in vivo biosensor working electrode responses.

If counter electrode 12 is close to working electrode 14, the value of Rₛ is small, as in the first illustrative biosensor configuration. However, the resistance Rᵤ of the resistive path between reference electrode 13 on the skin and the implanted working electrode 14 may be significant. With this type of electrode configuration, wherein the reference electrode is remote from the working electrode, there may exist a significant voltage (IR) drop, between the reference electrode and the working electrode. This configuration goes against the theoretical optimum where the reference electrode is as close as possible to the working electrode without causing shielding effects. In addition, the reference electrode is not disposed between the counter and working electrodes. For these reasons, third illustrative biosensor configuration 90 is not as favorable as second illustrative biosensor configuration 70. Nonetheless, with third illustrative biosensor configuration 90, the effect of changes in Rᵤ, due to biofouling, can be measured and used to compensate for biofouling.

The resistive components of Rᵤ are:

(a) the inherent electrical resistance of the working and reference electrodes R_{w}, Rᵣ, respectively;

(b) the electrical resistance across the skin Rₛₖᵢₙ;

(c) the electrical resistance within the bodily fluid/tissue outside the barrier membrane R_{Fo};

(d) the electrical resistance across membrane 40 Rₘₑₘ; and,

(e) the electrical resistance of the body fluid within the active zone is R_{Fi}; and, similar to equation 11, the total uncompensated resistance, Rᵤ, is expressed as:

Rᵤ=Rᵣ+Rₛₖᵢₙ+R_{Fo}+Rₘₑₘ+R_{Fi}+R_{w} (12)

### The resistive components of Rᵤ are very similar to the resistive components of Rₛ in FIG. 4B, and as such, they are of similar magnitude.

In third illustrative biosensor configuration 90, the reference electrode on the skin surface is far removed from the working electrode; therefore, a high value for Rᵤ may have an adverse effect on the time constant RᵤC_{dl} for the rise in poise potential. If the rise time, [RT]ₜ, of the working electrode voltage exceeds the pulse width period τ₁ of a periodically applied voltage waveform such as a square wave, the poise potential will not attain its maximum value within τ₁. This will cause a decrease in the biosensor response, leading to inaccuracy of the computed analyte concentration. As in the case of second biosensor illustrative configuration 70, most of the terms in equation 12 are either small or relatively constant; thus, the R_{biofouling} term is the variable component and therefore the total uncompensated resistance Rᵤ, and its effect on the poise potential, may be used to track the extent of biofouling.

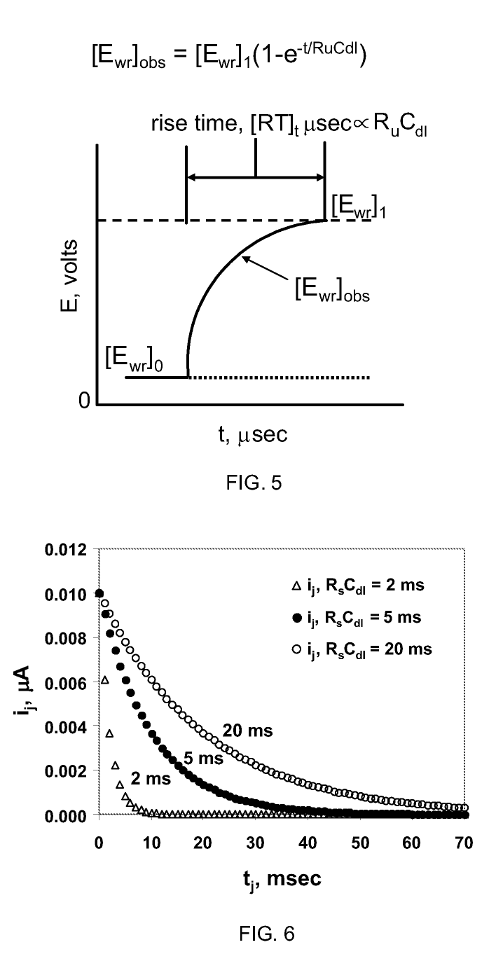

FIG. 5 shows a graph of the behavior of the poise potential [E_{wr}]₁, established between a working electrode and reference electrode, when a square wave voltage pulse is applied to the working electrode. FIG. 5 shows an ordinate labeled “E, volts” and an abscissa labeled in microseconds “t, μsec”. In FIG. 5, the graph of the exponential rise to the poise potential [E_{wr}]₁ is represented by the solid black line and is further labeled “[E_{wr}]_{obs}”.

Prior to reaching the desired poise potential [E_{wr}]₁, the observed potential ascends exponentially through a rise time [RT]ₜ, proportional to the time constant “RᵤC_{dl}”, in accordance with:

[E_{wr}]_{obs}=[E_{wr}]₁(1−e^{-t/RuCdl}) (13);

where [E_{wr}]_{obs} represents the observed potential on the exponentially rising part of the curve in FIG. 5. The rise time is governed by the time constant RᵤC_{dl}. As the uncompensated resistance Rᵤ and/or double layer capacitance C_{dl} increases, the time constant increases and the longer it will take for [E_{wr}]_{obs} to reach [E_{wr}]₁. The magnitude of Rᵤ can have a significant effect on the attainment of the poise potential within the pulse width period, τ₁. If the uncompensated resistance increases to the point where the rise time exceeds the pulse width period τ₁, the potential may fail to achieve the desired poise potential [E_{wr}]₁, and the signal output of the biosensor may be decreased.

### Biofouling's Effect on Electrical Resistance and Time Constants

FIG. 6 shows a graph of the effect of increasing Rₛ on biosensing current transients resulting from voltage pulses applied to a working electrode. In FIG. 6, the ordinate is labeled “iⱼ” and is marked in units of microamperes (μA); and, the abscissa is labeled “tⱼ” and is marked in milliseconds. Open triangles show a decay portion of a biosensing current transient for a time constant RₛC_{dl}=2 msec. Opaque circles show a decay portion of a biosensing current transient for a time constant RₛC_{dl}=5 msec. Open circles show a decay portion of a biosensing current transient for a time constant RₛC_{dl}=20 msec. For each value of RₛC_{dl}, Rₛ is the resistance (ohms) between the working and counter electrode and C_{dl} is the capacitance (μF) resulting from the electrical double layer charge arising at the working electrode's surface.

FIG. 6 demonstrates the effect of increasing Rₛ when a square-wave voltage pulse is applied to a working electrode for a fixed pulse width period τ₁ (e.g., 300 msec). Time constants are usually microseconds (10⁻⁶ sec) to milliseconds (10⁻³ sec), whereas pulse width periods [Pₜ] may be milliseconds to seconds. As the time constant RₛC_{dl} for the current decay increases, the rate of decay of the biosensing current transient decreases, and the peak width [P_{w}]ₜ of the biosensing current transient increases. The peak width may vary, while the pulse width period τ₁ is constant. The peak width of a current transient [P_{w}]ₜ is defined as the time difference between the peak current and the time where the peak current is half its value. Accordingly, the increase in the time constant RₛC_{dl} and its subsequent effect on peak width yields an indirect measurement of the effect of Rₛ on the magnitude of the biosensor current as a function of run-time.

### Fourth Illustrative Biosensor Configuration

FIG. 4D is a schematic representation of a fourth illustrative biosensor configuration 100, wherein working electrode 14 is implanted within a subject and both counter electrode 12 and reference electrode 13 contact the skin surface 10 of a subject. In FIG. 4D, the resistance paths between the reference 13 and counter 12 electrodes on the skin and the implanted working electrode 14 are shown as a dashed lines interrupted with resistor symbols, both Rₛ and Rᵤ have the same resistive components as described in FIG. 4B and FIG. 4C, respectively. Since both reference electrode 13 and counter electrode, 12 are outside membrane 40, in relatively stable environments; either can serve as an observer sensor (O) and provide a means of indirectly measuring the effect of biofouling on in vivo biosensor working electrode responses.

Although resistance and current magnitude play an important role in defining the applied voltage limitations of a potentiostat and the time constants of the applied working electrode voltage and the decay of current time transients, a major advantage is the implanted working electrode can be much smaller than either a biosensor wherein two or more electrodes are implanted. A smaller implanted sensor can reduce the inflammatory response and provide a sensor with less susceptibility to biofouling.

### Fifth Illustrative Biosensor Configuration

FIG. 4E is a schematic representation of a fifth illustrative biosensor configuration 110, in which all of the biosensor's electrodes are implanted within a subject as illustrated in FIG. 4A. As shown in FIG. 4E, counter electrode 12, reference electrode 13, and working electrode 14 are all implanted within the subject and encapsulated within a barrier membrane 40. In addition to the implanted electrodes, an additional electrode 15 contacts the skin surface.

In FIG. 4E, the resistance path between the implanted reference 13 and implanted working electrode 14 and the counter 12 electrode and implanted working electrode 14 are shown as dashed lines interrupted with resistor symbols. As in the first illustrative biosensor configuration, both Rₛ and Rᵤ are minimized and have the same resistive components as described in the first illustrative biosensor configuration 4A. Skin surface electrode 15 serves as an observer sensor (O) and provides a means for indirectly measuring the effect of biofouling on barrier membrane 40 by measuring the resistance between the skin surface and any of the implanted electrodes 12, 13 or 14. By measuring the relative difference between the resistance measured during the induction period and measurements taken after the induction period, a real-time biofouling correction algorithm may be used to compensate the sensor signal output, the sensitivity (S) or both.

The advantage of fifth illustrative biosensor configuration 110 is that resistance (Rₛ) between the counter and working electrode and between the reference and working electrode (Rᵤ) are minimized while electrode 15 provides a means for monitoring the resistance or impedance across membrane 40. This measurement provides a means for compensating for the effects of biofouling on analyte mass transfer across membrane 40. The disadvantage is that a larger sensor is implanted which may lead to an increased inflammatory response. Regardless of the size of the biosensor, if the inflammatory response is limited to an acute phase, changes in sensor signal outputs, and their impact on accuracy and sensitivity can be minimized.

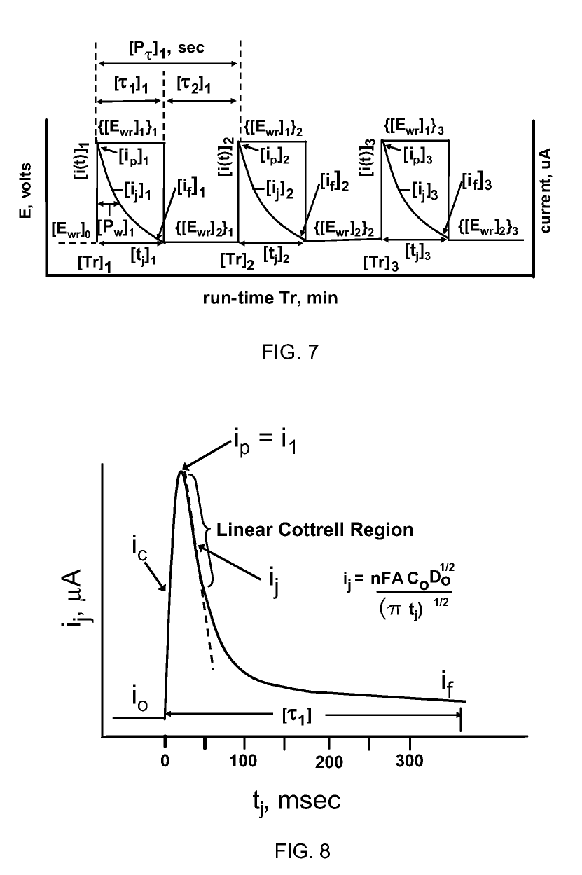

FIG. 7 shows a graph of a series of square-wave voltage pulses, having a constant pulse width period τ₁ and corresponding entrained current transients [i(t)]ₙ resulting from their application to the working electrode of a 3-electrode electrochemical cell. In FIG. 7, the left ordinate represents relative voltage and is labeled “E, volts”, the right ordinate represents transient current and is labeled “current, μA”, and the common abscissa is labeled “run-time Tr, min”. An opposing arrow around “[Pw]ₙ,” identifies the peak width of a current transient in sec. The subscript n indicates that the variable is indexed to the runtime [Tr]ₙ. An opposing arrow about the words “[P_{τ}]ₙ, sec” identifies the total period of a square wave voltage pulse in seconds and is the sum of the pulse-width period, identified by an opposing arrow around the words “τ₁, sec”, and an inter-pulse period identified by the opposing arrow around the words “τ₂, sec”. The inter-pulse period is also associated with a voltage identified by {[E_{wr}]₂}ₙ.

In FIG. 7, the label “[E_{wr}]₂” defines the magnitude of the potential difference across the working and reference electrodes during the inter-pulse period. The value of [E_{wr}]₂ may be:

(a) the open circuit potential defined as [E]_{oc}; or,

(b) any potential less than or greater than [E_{wr}]₁; or,

(c) the value of the potential difference that is operative during a disconnect period between pulses when no current flows.

A disconnect period is defined as the time over which there is a break in the electrical contact between the working and reference electrodes, or between the working and counter electrodes. The difference between an open circuit period and a disconnect period is that at open circuit, the working and reference electrodes remain connected with no external voltage applied with little current flowing; however, there is still a potential difference between the working and reference electrode. The potential difference during open circuit is attributable to the redox behavior of half-cells or “battery effects” due to differences in material comprising the working and reference electrodes and the electrolyte solution(s) surrounding the electrodes.

In FIG. 7, in response to each voltage pulse [E_{wr}]₁, each biosensing current transient [i(t)]ₙ rises steeply to a peak value, represented by the symbol [iₚ]ₙ; after which, it declines exponentially to a final current value [i_{f}]ₙ at the end of the pulse width period. The subscript n (n=1, 2, 3 . . . ) indicates each current transient is indexed to a discrete value of the run-time [Tr]ₙ. Each run-time point [Tr]ₙ is defined as the time when the voltage pulse begins, the subscript j (j=1, 2, 3 . . . ) represents declining transient currents [iⱼ]ₙ and corresponding transient times [tⱼ]ₙ after the peak current and the maximum value of subscript j is a function of the sampling rate (Hz) and the pulse width period (τ₁). For a diffusion controlled process, the post peak transient current is defined by the Cottrell Equation:

iⱼ=nFACₒDₒ^{1/2}/(πtⱼ)^{1/2} (14)

where,

iⱼ=the biosensing current on the falling portion of the current transient in Amps

n=number of electrons transferred, equivalents/mol (1, 2, 3 . . . )

F=Faraday constant, 96,485 Coulombs/equivalent

A=electrode area, cm²

Cₒ=initial mass concentration of the analyte, mol/cm³ (molality)

Dₒ=initial diffusion coefficient of the analyte, cm²/sec

tⱼ=transient time, sec.

The transient current is inversely proportional to the square root of transient time tⱼ; and, for a diffusion-controlled reaction at a planar electrode, the product iⱼ*(tⱼ^{1/2}) should be constant. In addition, there is a linear portion of the exponentially declining current transient that begins at the peak current i₁ and ends at a time tⱼ where the current becomes non-linear. This linear region exists for approximately 2-100 msec after the peak current.

Biosensing currents referred to herein may consist of discrete single transient currents [iⱼ]ₙ, the difference between two transient currents [i₂−i₁]ₙ, an average transient current, the rate of change of the transient current or integrated transient current expressed as charge in coulombs, in accordance with Faraday's Laws where charge is expressed as a change in current multiplied by a corresponding change in time.

In order to obtain calibrated values of an analyte concentration, each discretely sampled indexed transient current [iⱼ]ₙ, integrated transient current or function of the transient current used as a biosensing output response, for the calculation of an analyte concentration, must be calibrated against known analyte concentrations so that calibration parameters such as sensitivity and intercept may be determined.

In FIG. 7, at each voltage pulse beginning at [Tr]ₙ, (n=1, 2, 3, . . . ), the voltage rises from a baseline magnitude of [E_{wr}]₀ to the maximum of the poise potential [E_{wr}]₁. The magnitude of [E_{wr}]₁, is preferably selected to enable an optimized rate of an electrochemical redox reaction. The maximum may or may not be the diffusion limited rate. After a time period defined by the pulse-width τ₁, [E_{wr}]₁ may be stepped to [E_{wr}]₂ for the duration of the inter-pulse period τ₂. The magnitude of [E_{wr}]₂ is preferably chosen such that the electrochemical redox reaction (e.g. electro-oxidation of H₂O₂) still proceeds, but at a reduced rate versus the rate at [E_{wr}]₁. When [E_{wr}]₂ is less than [E_{wr}]₁, the concentration of the analyte species within [E_{wr}]₂ (τ₂) will be greater than its concentration within the pulse width period, τ₁, of [E_{wr}]₁. With respect to amperometric glucose oxidase biosensors, the oxidation of glucose by GOx proceeds in the absence of an applied potential such that hydrogen peroxide may increase during the inter-pulse period.

If the magnitude of the square wave voltage pulse [E_{wr}]₁, the total period P_{τ} and the pulse width period τ₁ are judiciously chosen, the concentration of an analyte species, such as hydrogen peroxide, can be controlled so that when the pulsed voltage [E_{wr}]₁ is applied, the analyte concentration within the active zone temporarily falls to zero within the pulse width period, τ₁ and increases again during the inter-pulse period τ₂.

The final current value [i_{f}], may be a function of the final current, such as an averaged or integrated transient current immediately preceding the final transient current value. In some cases, the final current function may be used as the y-intercept bₖ in equation 4, supra, and with appropriate substitution of subscripts, equation 4 becomes:

[C]_{Tr}={[iⱼ]−[i_{f}]}_{Tr}/Sₖ (15),

where:

(a) [C]_{Tr} is the concentration of glucose corresponding to a function of the run-time indexed transient current, in this case a run-time indexed current difference;

(b) [iⱼ] is any current, preferably the peak current, on the declining portion of the run-time indexed current transient and [i_{f}] is the final current within the same run-time indexed current transient and,

(c) Sₖ represents the sensitivity determined at a run-time other than the run-time indexed transient currents.

### Although the current function in equation 15 is a current difference, it could also be a function of integrated currents within a selected transient time range, (dtⱼ).

FIG. 8 shows a more detailed view of one of the biosensing current transients appearing in response to a voltage pulse shown in FIG. 7. The ordinate of the graph in FIG. 8 represents transient current and is labeled “iⱼ, μA.” The abscissa of the graph shown in FIG. 8 represents transient time in milliseconds (msec) and is labeled “tⱼ, msec.”

In FIG. 8, the biosensing current transient rises steeply from an initial current, iₒ, as a non-faradaic, double layer charging current i_{c}, to a peak value, iₚ=i₁, then declines exponentially. The exponential decline in iⱼ can be approximated by the Cottrell Equation (14). At the peak current value, the rate of the redox reaction is at its maximum and an analyte, such as hydrogen peroxide, is rapidly consumed during the pulse width period τ₁, resulting in currents iⱼ that decline from the peak value i₁ to a final current of if at the end of the pulse width period.

The number of discrete time points tⱼ is determined by a sampling rate and pulse width τ₁. For example, if the sampling rate is 500 Hz, then the number of time points tⱼ within a pulse width, τ₁, of 0.3 sec is (0.3)(500)=150, with intervening increments of 2 msec. In this case, the final current i_{f} would be designated i₁₅₀. If an average final current is used, then the average should be taken within a time range immediately preceding iⱼ₁₅₀ such as, for example, between i₁₄₀ and i₁₅₀, which equates to the average of 6 current values. The same holds true for integration of the final current.

As indicated, supra, the biosensing transient current declines exponentially and can be described as:

iⱼ=([E_{wr}]₁/Rₛ)(e^{-tj/RsCdl}) (16)

By rearranging terms in equation 16 and taking the natural log(Ln) of both sides of equation 16:

Ln[iⱼ]=−[1/(RₛC_{dl})]tⱼ+Ln{[E_{wr}]₁/Rs} (17)

Equation 17 is in the form of y=mx+b, where m is the slope and b is the y-intercept. In equation 17, the term [−(1/RₛC_{dl})] is the slope; and the term Ln{[E_{wr}]₁/Rs} is the y-intercept.

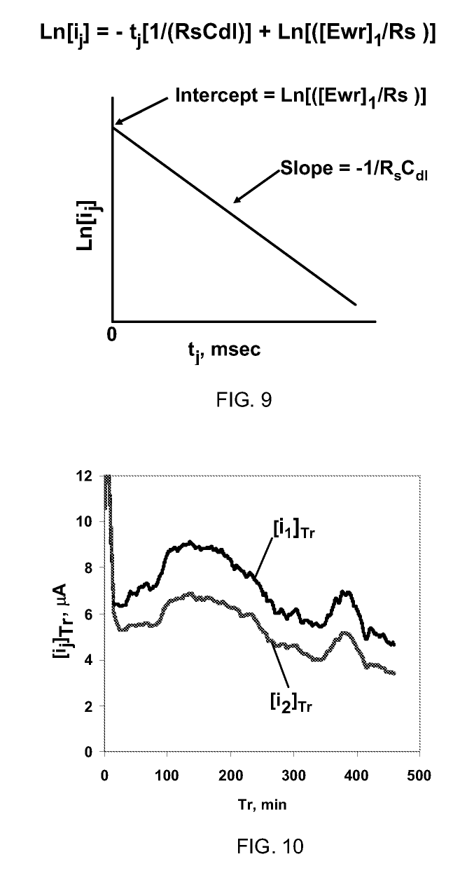

FIG. 9 shows a graph of equation 17, with Ln[iⱼ] plotted against transient time tⱼ. In FIG. 9, the ordinate represents the natural logarithm of the transient current and is labeled “Ln[iⱼ]”. The abscissa represents transient time in msec and is labeled “tⱼ, msec”.

Since the poise potential [E_{wr}]₁ is either known or measured, a determination of Rₛ from the y-intercept Ln{[E_{wr}]i/Rₛ} is possible. Relative changes in the slope [−(1/RₛC_{dl})] with run-time may be used to calculate gain adjustment functions that may be used to adjust drifting biosensing signal outputs, as more fully described, below.

As capacitance C_{dl}, and/or resistance Rₛ increases, the value of 1/RₛC_{dl} decreases and, as indicated above in connection with FIG. 6, the run-time indexed transient peak width [P_{w}]ₙ of the biosensing current transient increases.

The transient peak width [P_{w}]ₙ of biosensing current transients, such as those shown in FIG. 7, is defined as the time required for the current transient to decline from its peak value at [iₚ], to a value of 50% of the peak value [iₚ]/2; i.e., the transient peak width in msec is determined by the difference between the transient times at tₚ and t_{p/2}. Increasing values of [P_{w}]ₙ indicate an increasing time constant due to increases in Rₛ and/or C_{dl} between the implanted biosensor and the skin surface observer sensor (R, C or O). As described infra, temporal changes in transient peak widths can be used to adjust for drifting biosensing current responses.

When studied under controlled laboratory conditions such as with aqueous buffer solutions, the behavior of electrochemical biosensors is well defined. However, the behavior of electrochemical biosensors under non-laboratory conditions may be unpredictable. This is particularly true for electrochemical biosensors implanted within mammals.

### Gain Adjustment Functions

When implanted in vivo, biosensors are affected, to varying degrees, by the body's foreign body response. The effect the foregoing process has on biosensor signal outputs is termed biofouling. Heretofore, there were no real-time algorithms, derived from information contained within biosensing currents, to account for drifting biosensor signal output caused by biofouling. As described below, a number of methods and gain adjustment functions are presented that can be used, on a real-time basis, to adjust drifting biosensor responses for the effects of biofouling.

The calculation of relative gain adjustment functions is based on information contained within current transients generated by the application of a voltage waveform, such as a square wave voltage pulse applied to the working electrode of an implanted biosensor. Relative changes in gain functions measured at run-times greater than an induction period versus gain functions measured during a baseline period, are used to compensate for biofouling. The calculation and application of gain adjustments occurs, on a real-time basis. For example, if the information contained within a series of voltage pulses is used to calculate baseline values of relative gain adjustment functions, within a baseline period, and if the change in these baseline values and those measured at run-times greater than the induction period exceed certain limits, a gain adjustment may be applied to biosensing signal output, sensitivity or both at run-time points greater than the induction period.

### Applied Potential Gain Adjustment Function

Referring to the second illustrative biosensor configuration of FIG. 4B, supra, wherein the working electrode and reference electrode are implanted within a subject, and the counter electrode serves as an observer sensor on the skin surface of a subject, changes in the applied voltage {[E_{wc}]₁}_{Tr} between the working electrode and counter electrode provides a basis for applying an applied potential gain adjustment function [G_{wc}]_{Tr} to the biosensing current.

The applied potential gain adjustment equation is a function of the applied voltage [E_{wc}]_{Tr} between the working electrode and the counter electrode. The applied voltage [E_{wc}]_{Tr} varies to maintain a constant poise potential [E_{wr}]₁ and constant inter-pulse potential [E_{wr}]₂ between the working electrode and the reference electrode. If the resistance Rₛ between a counter electrode and a working electrode changes, the applied voltage from a potentiostat will also change in order to maintain a constant poise or inter-pulse potential between the working electrode and counter electrode.

Since the resistance Rₛ between a skin surface observer sensor (O) and an in vivo working electrode includes a contribution from biofouling, then [E_{wc}]_{Tr}, the voltage applied across the working electrode and the counter electrode will indirectly reflect increases in resistance Rₛ caused by biofouling of the barrier membrane. Accordingly, relative changes in applied potential due to changes in Rₛ between a skin surface counter electrode and working electrode of an in vivo biosensor may be used to calculate an applied potential gain adjustment function.

A mathematical expression for an applied potential gain adjustment function [G_{wc}]_{Tr} at any time Tr, greater than the induction period, may be computed as follows:

[G_{Ewc}]_{Tr}=1+{([E_{wc}]_{Tr}−[E_{wc}]₀)/[E_{wc}]₀} (18)

where, [E_{wc}]₀ refers to an average of the applied potential taken over the baseline period, [E_{wc}]_{Tr} is the run-time indexed applied voltage between the working electrode and the counter electrode at any time Tr greater than the induction period; and, by definition, when [E_{wc}]_{Tr}=[E_{wc}]₀, then from equation 18, [G_{Ewc}]_{Tr}=1. The second term in equation 19 is a relative difference function of [E_{wc}]_{Tr} and [E_{wc}]₀.

For measurements taken on a continuous basis, the applied potential gain adjustment function [G_{Ewc}]_{Tr} may be used to adjust a single, discretely sampled transient current [iⱼ]_{Tr}; multiple, discretely sampled, transient currents; a difference between two discretely sampled transient currents; an integrated transient current between two transient time points or integration over a range of multiple, discretely sampled transient currents at any time Tr greater than the induction period. The measured value of [G_{Ewc}]_{Tr} or its reciprocal may be used, such that,

f{[iⱼ]_{Tr}}_{A}=[G_{Ewc}]_{Tr}*f{[iⱼ]_{Tr}} (19);

where the subscript, A, represents an adjusted function of the transient current(s) proportional to the analyte concentration and f{[iⱼ]_{Tr}} represents the unadjusted function of the transient current(s) as a function of analyte concentration.

The applied voltage gain adjustment function [G_{Ewc}]_{Tr} may be used to adjust the sensitivity Sₖ of the biosensor by multiplying or dividing the sensitivity Sₖ by [G_{Ewc}]_{Tr}:

[S]_{Tr}=[Sₖ]/[G_{Ewc}]_{Tr} (20),

where [Sₖ] is a previous sensitivity value and [S]_{Tr} is the adjusted sensitivity at the same run-time point were [G_{Ewc}]_{Tr} and the analyte concentration dependent transient current function were measured.

### Resistance Gain Adjustment Function

Referring again to the second illustrative biosensor configuration of FIG. 4B supra, wherein the working electrode and reference electrode are implanted in a subject, and the counter electrode contacts the skin surface of a subject, a direct measurement of R_{S} is also possible by independently measuring the resistance between the working and counter electrodes during the inter-pulse period, t₂. If [R_{S}]_{Tr} values at any time greater than the induction period are compared, on a relative difference basis, by an [R_{S}]ₒ value or average of [R_{S}]ₒ values measured within an induction period, the relative difference values may be used in a resistance gain adjustment function:

[G_{Rs}]_{Tr}=1+{([R_{S}]_{Tr}−[R_{S}]₀)/[R_{S}]₀} (21);

where [R_{S}]_{Tr} is the resistance between the implanted working electrode and the skin surface counter electrode at any time Tr greater than the induction period; and, [R_{S}]₀ refers to an average taken over the baseline period. By definition, when [R_{S}]_{Tr}=[R_{S}]₀, then from equation 21, [G_{Rs}]_{Tr}=1. As in equation 18, supra, the second term in equation 21 is a relative difference function of [R_{S}]_{Tr}.
For measurements taken on a continuous basis, the Rₛ resistance gain adjustment function [G_{Rs}]_{Tr} may be used to adjust a single, discretely sampled transient current [iⱼ]_{Tr}; multiple, discretely sampled transient currents; a difference between two discretely sampled transient currents; an integrated transient current between two transient time points or integration over a range of multiple, discretely sampled transient currents at any time Tr greater than the induction period. The value of [G_{Rs}]_{Tr} or its reciprocal may be used:

f{[iⱼ]_{Tr}}_{A}=[G_{Rs}]_{Tr}·f{[iⱼ)]_{Tr}} (22);

where the subscript, A, represents an adjusted function of the transient current(s) proportional to the analyte concentration and f{[iⱼ]_{Tr}} represents the unadjusted function of the transient current(s) as a function of the analyte concentration.

The resistive gain adjustment function [G_{Rs}]_{Tr} may be used to adjust the sensitivity Sₖ of the biosensor by multiplying or dividing the sensitivity as follows:

[S]_{Tr}=[Sₖ]/[G_{Rs}]_{Tr} (23),

where [Sₖ] is a previous sensitivity value and [S]_{Tr} is the adjusted sensitivity at the same run-time point where [G_{Rs}]_{Tr} and the analyte concentration dependent current function were measured.

### Transient Peak Width Gain Adjustment Function

Again referring again to the second illustrative biosensor configuration of FIG. 4B, supra, wherein the working electrode and reference electrode are implanted in a subject, and the counter electrode only contacts the skin of the subject. As previously pointed out in reference to FIG. 6, as R_{S} and/or C_{dl} increases, the peak width of the current transient also increases. Measurement of the peak width [P_{w}]_{Tr} of run-time indexed current transients, provides a basis for calculating a gain function. If [P_{w}]_{Tr} values at any time greater than the induction period Tr are normalized by a [P_{w}]_{Tr} value or average of [P_{w}]_{Tr} values measured within the induction period, the normalized values may be used in a transient peak width gain adjustment function:

[G_{Pw}]_{Tr}=1+{([P_{w}]_{Tr}−[P_{w}]₀)/[P_{w}]₀} (24);

where [P_{w}]_{Tr} is the transient peak width at any time Tr greater than the induction period; and, [P_{w}]₀ refers to an average transient peak width taken over the baseline period. By definition, when [P_{w}]_{Tr}=[P_{w}]₀, then from equation 24, [P_{w}]_{Tr}=1.

For measurements taken on a continuous basis, the transient peak width gain adjustment function [G_{Pw}]_{Tr} may be used to adjust a single, discretely sampled transient current [iⱼ]_{Tr}; multiple, discretely sampled, transient currents; a difference in transient currents; an integrated transient current between two transient time points or integration over a range of multiple, sampled transient currents at any time Tr greater than the induction period. Accordingly,

f{[iⱼ]_{Tr}}_{A}=[G_{Pw}]_{Tr}·f{[iⱼ]_{Tr}} (25);

where the subscript, A, represents an adjusted function of the transient current(s) proportional to the analyte concentration and f{[iⱼ]_{Tr}} represents the unadjusted function of the transient current(s) as a function of analyte concentration.

The transient peak width gain adjustment function [G_{Pw}]_{Tr} may be used to adjust the sensitivity Sₖ of the biosensor by multiplying or dividing the sensitivity as follows:

[S]_{Tr}=[Sₖ]/[G_{Pw}]_{Tr} (26),

where [Sₖ] is a previous sensitivity value and [S]_{Tr} is the adjusted initial sensitivity at the same run-time point where

### [G_{Pw}]_{Tr} and the analyte concentration dependent current function were measured.

### Poise Potential Gain Adjustment Function

Referring to the third illustrative biosensor configuration of FIG. 4C, supra, wherein the working and counter electrodes are implanted within the skin of a subject, and the reference electrode serves not only as a reference electrode, but also as an observer sensor on the skin surface of the subject. If a series of square-wave voltage pulses is applied between an implanted working and counter electrode, then the beginning of each pulse may be identified by a characteristic run-time value [Tr]ₙ. In FIG. 5, the rise time [RT]ₜ of each voltage pulse is the time between the initial application of the voltage at [E_{wr}]₀ and the time when the poise voltage rises to its maximum value of [E_{wr}]₁. Rise times are normally quite short (microseconds); however, large values of Rᵤ and/or C_{dl} and consequently longer time constants, may not allow the poise potential to reach its maximum value within the pulse width period, τ₁. This may result in a lower poise potential with a subsequent decrease in the biosensing current. By measuring the relative change in poise potential over a time interval Tr greater than the induction period, [Tr]_{induction}, a poise potential gain adjustment function may be calculated.

For example, if the desired poise potential, [E_{wr}]₁, is 0.500 volts with respect to a reference electrode, such as silver/silver chloride, then measuring the relative difference between the desired poise potential and the observed poise potential provides a means of applying a poise potential gain adjustment to the measured biosensing current. The poise potential is measured near the end of the pulse width period, τ₁, and the relative difference between the measured value and the desired value is used in a poise potential gain adjustment function represented by the following equation:

[G_{Ewr}]_{Tr}=1+{([E_{wr}]_{Tr}−[E_{wr}]₀}/[E_{wr}]₀} (27),

Where [G_{Ewr}]_{Tr} is the measured poise potential indexed to any time Tr after the induction period and [E_{wr}]₀ is the average measured poise potential within the baseline period. Each discretely sampled output biosensing current value [iⱼ]_{Tr}, beyond the induction period is multiplied by [G_{Ewr}]_{Tr} to obtain an adjusted biosensing current value:

{[iⱼ]_{Tr}}_{A}=[G_{Ewr}]_{Tr}*[iⱼ]_{Tr} (28)

where the subscript, A, represents an adjusted function of the transient current(s) proportional to the analyte concentration and f{[iⱼ]_{Tr}} represents the unadjusted function of the transient current. By definition, when [E_{wr}]_{Tr}=[E_{wc}]₀, then from equation 28, [G_{Ewr}]_{Tr}=1. The poise potential gain adjustment function [G_{Ewr}]_{Tr} may be used to adjust the sensitivity Sₖ, by multiplying or dividing the sensitivity as follows:

[S]_{Tr}=[Sₖ]/[G_{Ewr}]_{Tr} (29)

where [Sₖ] is a previous sensitivity value and [S]_{Tr} is the adjusted sensitivity at the same run-time point were [G_{Ewr}]_{Tr} and the analyte concentration dependent current(s), were measured.

### Current Transient Gain Adjustment Function

In the following examples, biosensing current transients were generated by periodically applying a 0.500-volt voltage pulse versus a silver-silver chloride reference electrode, across an implanted working electrode and a counter electrode of an intradermal glucose oxidase biosensor. The total pulse period PT was 5 sec and the pulse width period τ₁ was 300 msec and by difference τ₂ equals 4.7 sec.

Pulse-widths from milliseconds to seconds may be used; however, it is preferable to select a pulse-width that allows consumption of the bulk of an electroactive species (e.g., hydrogen peroxide) created during the ensuing inter-pulse period, τ₂. This is especially true for an amperometric, GOx biosensors, wherein excess accumulation of hydrogen peroxide may have a deleterious effect on enzyme stability. A preferred range of pulse widths is 0.050-100 sec., with pulse widths of 0.050-10.0 sec more preferable.

The inter-pulse period τ₂ must be longer than the pulse width period τ₁ (e.g. τ₂=10τ₁). It is preferable to provide an inter-pulse period τ₂ sufficient to allow accumulation of the electroactive species (e.g., hydrogen peroxide) between pulses. The resulting peak current iₚ of the biosensing current transient will yield an enhanced biosensor response with a higher signal to noise ratio compared with shorter inter-pulse periods. Inter-pulse periods of 1 to 600 seconds are preferable, with inter-pulse periods of 1-60 seconds being more preferable.

In the following calculations, two data points from each current transient in response to a square wave voltage pulse are selected to compute a relative difference function defined as:

[RD1]_{Tr}=[(i₁−i₂)/i₁]_{Tr} (30)

where i₁ and i₂ are two discretely sampled transient currents within a run-time indexed biosensing current transient where i₁>i₂. Preferably:

(a) [i₁]_{Tr} is the transient peak current or a transient current value near the peak value; and,

(b) [i₂]_{Tr} is the value of a biosensing transient current iⱼ within the linear portion of the declining transient current where [i₂]_{Tr} is less than [i₁]_{Tr} and the transient time between the two currents is held constant during the run-time period.

(c) the subscript Tr indicates that each value of [RD1] and iⱼ are indexed to the same run-time point.

FIG. 10 shows a graph of a biosensor's drifting response current as a function of run-time for each of the two sampled transient current values [i₁]_{Tr} and [i₂]_{Tr} obtained by periodic pulsing of the voltage across an implanted working electrode and a skin contact counter electrode. In the graph shown in FIG. 10, the ordinate is labeled “[iⱼ]_{Tr}, μA” and is scaled in units of microamps (μA); and, the abscissa is labeled “Tr” and is scaled in units of minutes.

In FIG. 10, the graph labeled [i₁]_{Tr} is comprised of points corresponding to peak values [iₚ]_{Tr} or [i₁]_{Tr} of biosensing current transients, generated in response to square wave voltage pulses, as a function of run-time Tr; and, the graph labeled [i₂]_{Tr} is comprised of run-time indexed points corresponding to values of biosensing transient currents measured at a fixed transient time interval, dtⱼ, after the peak current [i₁]_{Tr}. It is preferable to use a relatively short dtⱼ, approximately 5-20 msec. In the case of the data in FIG. 10, the value of dtⱼ, was 10 msec.

Using at least the foregoing two data points [i₁]_{Tr} and [i₂]_{Tr}, respectively selected from the same run-time indexed biosensing current transient and shown plotted against the run-time Tr in FIG. 10, values of the relative difference function [RD1]_{Tr}, were calculated, according to equation 30, from sets of indexed values of [i₁]_{Tr} and [i₂]_{Tr} obtained from n current transients.

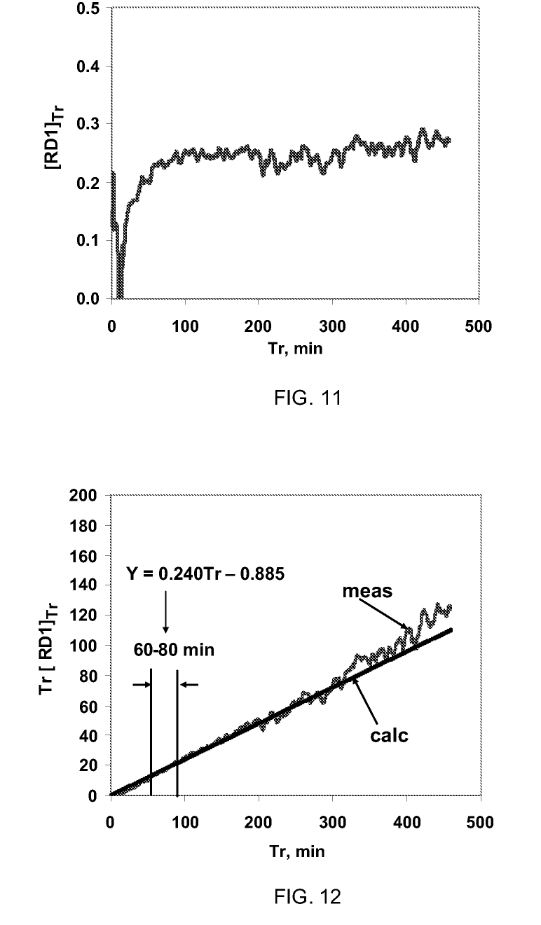

FIG. 11 shows a graph of measured values of the difference function [RD1]_{Tr} obtained by using paired values of discretely sampled transient currents [i₁]_{Tr} and [i₂]_{Tr}, within same run-time indexed current transient (in the graph shown in FIG. 10). As shown in FIG. 11, the measured values of the difference function [RD]_{Tr} are noisy and appear to reach a constant value. To remove the noise and obtain a smooth difference function, the measured values of [RD1]_{Tr} were first linearized by multiplying each value of [RD1]_{Tr} by its corresponding run-time Tr.

FIG. 12 shows a graph of values of [RD1]_{Tr} multiplied by its corresponding run-time Tr to yield time-transformed data points Tr[RD1]_{Tr}. In FIG. 12, the ordinate is labeled “Tr[RD1]_{Tr}”; and, the abscissa is labeled “Tr” and represents run-time, scaled in minutes. Performance of linear regression on the time-transformed data points Tr[RD1]_{Tr}, over the bracketed run-time range of 60-80 minutes, within the baseline period, yields a linear equation:

Tr[RD1]_{Tr}=0.240Tr−0.885 (31);

represented by the solid straight line in FIG. 12, having:

(a) slope m_{Tr} of 0.240; and,

(b) y-intercept of −0.885

### Calculated values of Tᵣ[RD1]_{Tr} at run-times greater than 80 min were determined, using equation 31. The black jagged line in FIG. 12 are the measured values of Tr[RD]_{Tr}.

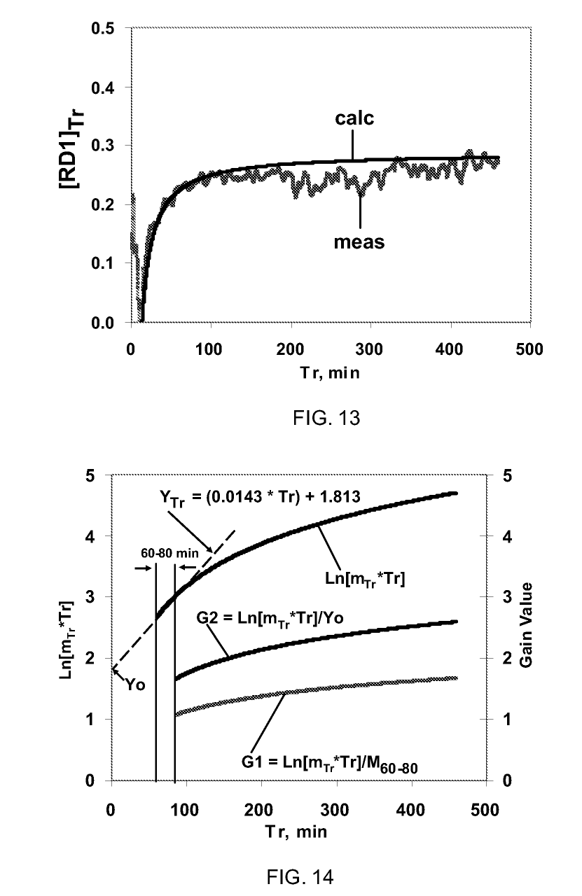

FIG. 13 shows a graph of the measured values of [RD1]_{Tr}, from FIG. 11, plotted along with calculated values of [RD1]_{Tr} determined by dividing the calculated values of Tr[RD1]_{Tr}, from equation 31, by their corresponding run-time values Tr. In the graphs shown in FIG. 13, the ordinate is labeled [RD1]_{Tr} and is dimensionless; the abscissa is labeled “Tr” and is scaled in units of 100 minutes. The graph labeled “calc” demonstrates the smoothing of the noisy measured graph labeled “meas” also shown in FIG. 11. The following steps summarize how the “meas” and “calc” values in FIG. 13 were determined:

(a) The “meas” graph (also shown in FIG. 11) was obtained by plotting each measured value of [RD1]_{Tr}, determined by application of equation 30, against its corresponding run-time value of Tr; and,

(b) The “calc” graph was obtained by: (1) performing linear regression on the measured values of Tr[RD1]_{Tr}, as in FIG. 12, over a selected run-time range Tr (60-80 min) within the baseline period; and (2) at run-times greater than the induction period calculated values of Tr[RD1]_{Tr} were determined from equation 31; and, (3) calculated values of [RD1]_{Tr} were extracted from the calculated values of Tr [RD1]_{Tr} beyond the induction period, by dividing each calculated value of Tr [RD1]_{Tr} by its corresponding run-time value Tr.

So as not to introduce unwanted noise into the adjusted values of the biosensing signal output or sensitivity, smooth gain adjustment functions are preferred. The natural log(Ln) of the calculated values of Tr[RD1]_{Tr} from FIG. 12 provide two such functions.

### Gain Adjustment Functions G1 And G2

Theoretically, the y-intercept of the regression line within the baseline period in FIG. 12 should be zero. In practice, there may exist a small, non-zero y-intercept; however, for calculations herein, a zero y-intercept was assumed.

In order to determine the gain adjustment functions for biosensing currents at run-time points beyond the induction period, the natural log of calculated values of Tr[RD]_{Tr} is taken for each Tr value greater than the induction period:

Ln{Tr[RD1]_{Tr}}=Ln[m_{Tr}*Tr] (32)

FIG. 14 shows graphs used in the calculation of the gain adjustment functions G1 and G2. In the graph shown in FIG. 14, the ordinate is labeled “Ln[m_{Tr}*Tr]” and the abscissa is labeled “Tr, min,” and is scaled in units of a 100 minutes. At the top of FIG. 14, there is a linear expression obtained by linear regression of measured Ln[m_{Tr}*Tr] values over a time period within the baseline period (60-80 min):

Y_{Tr}=(0.0143*Tr)+1.813 (33);

with a slope of 0.0143 and a y-intercept, Yₒ, of 1.813 that identifies a straight dashed line labeled Y_{Tr}. The linear regression period used to derive equation 33 was performed within the vertical bars delineating the selected run-time range of 60-80 minutes, within the baseline period. In performing linear regression within the 60-80 minute window, linearity of the Ln[m_{Tr}*Tr] data points was assumed over the selected run-time range of 60-80 minutes. This is a valid assumption because the linear correlation coefficient for the data, within the selected run-time range, was 0.999. The y-intercept of the Y_{Tr} line is non-zero and is defined as Yₒ.

In FIG. 14, the G1 gain adjustment function represents a non-drifting biosensor in which little or no drift occurs after the induction period. For the G1 gain function, values of Ln[m_{Tr}*Tr] beyond the induction period are normalized by the median value of Ln[m_{Tr}*Tr] corresponding to the beginning of the run-time range at Tr=60 minutes, {Ln[m_{Tr}*Tr]}60, and the value of {Ln[m_{Tr}*Tr]}Tr corresponding to the end of the run-time range at Tr=80 minutes, {Ln[m_{Tr}*Tr]}80. The median value is defined as:

({Ln[m_{Tr}*Tr]}₆₀+{Ln[m_{Tr}*Tr]}₈₀)*0.5=M₆₀₋₈₀ (34)

The notation M₆₀₋₈₀ represents the median value of the function Ln[m_{Tr}*Tr] at 60 and 80 minutes. The normalized values of Ln[m_{Tr}*Tr] are denoted by the lower curve, labeled:

G1=Ln[m_{Tr}*Tr]/M₆₀₋₈₀ (35)

### The values of G1 are computed at run-times greater than the induction period.

In FIG. 14, the G2 gain adjustment function represents a drifting biosensor where drift occurs beyond the induction period, and takes into account that the magnitude of future drift is related to what occurred at the biosensing interface, between the biosensor membrane surface and surrounding tissue or fluid, during the induction period. The values of the G2 gain adjustment function are calculated by dividing (or normalizing) calculated values of Ln[m_{Tr}*Tr] beyond the induction period by the y-intercept (Yₒ). These values are denoted by the middle curve labeled:

G2=Ln[m_{Tr}*Tr]/Yₒ (36)

### The values of G2 are computed at run-times greater than the induction period.

### When to Use Gain Adjustment Functions

There are numerous ways G1 and G2 may be used to adjust a biosensor's signal response to compensate for the effects of drift and biofouling. G1 and G2 values alone may be used as well as functions of G1 and G2 such as the ratio G1/G2, average (G1+G2)/2, difference (G2−G1), etc., determined at each run-time point, Tr.

Whether to apply a gain adjustment, beyond the induction period, can be predicated on information obtained within the baseline period or in other cases, data measured after the induction period. For example, certain biofouling parameters calculated within the baseline period, e.g. m_{Tr}, may be above or below a certain threshold limit and biofouling parameters outside threshold values may be used to trigger a gain correction that is applied to all biosensor signal outputs beyond the induction period. Several types of threshold values are discussed below.

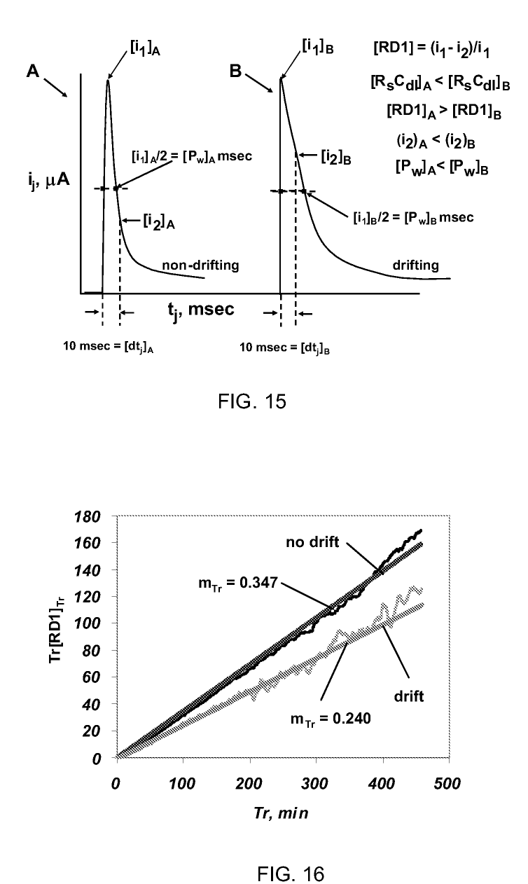

FIG. 15 shows graphical representations of hypothetical current transients for drifting and non-drifting in vivo biosensor responses. In the graphs shown in FIG. 15, the abscissa is labeled “iⱼ, μA” and is scaled in microamps; and, the ordinate is labeled “tⱼ, msec.”

The graph to the left labeled A:

(a) is associated with a time constant [RₛC_{dl}]_{A};

(b) is labeled “non-drifting”; and,

(c) shows the decline in transient current from [i₁]_{A} to [i₂]_{A}, after a fixed period, dtⱼ, of 10 msec.;

(d) shows the value of the biosensing current at half of the peak value labeled “[i₁]_{A}/2=[P_{w}]_{A}”.

The graph to the right labeled B:

(a) is associated with a time constant [RₛC_{dl}]_{B}

(b) is labeled “drifting”; and,

(c) shows the decline in transient current from [i₁]_{B} to [i₂]_{B}, after a fixed period of 10 msec.;

(d) shows the value of the biosensing current at half of the peak value labeled “[i₁]_{B}/2=[P_{w}]_{B}”.

### In each graph, paired vertical dashed lines demarcate a time window, dtⱼ, of 10 msec.

The relative difference function [RD1] is defined from equation 30 as [RD1]=(i₁−i₂)/i₁. In comparing the graph on the left (A) to the graph on the right (B):

[RₛC_{dl}]_{A}<[RₛC_{dl}]_{B};

[RD1]_{A}>[RD1]_{B};

[i₂]_{A}<[i₂]_{B}; and,

[P_{w}]_{A}<[P_{w}]_{B}

FIG. 15 illustrates that if the resistance Rₛ and/or capacitance C_{dl} increases owing to biofouling, then:

(a) RₛC_{dl} increases (graph B): and,

(b) the peak width of the current-time transient within the 10 msec window also increases; and,

(c) broadening of the current transient leads to values of [RD1] that may be less than that of a non-drifting sensor, i.e., [RD1]_{B}<[RD1]_{A}; and,

(d) establishing threshold values for parameters obtained from biosensor output signals, within the baseline period, may be used to determine whether drift adjustments are necessary to biosensing output signals beyond the induction period.

FIG. 16 shows two graphs of measured and calculated values of Tr[RD1]_{Tr} as a function of run-time for drifting and non-drifting biosensor output current responses. In FIG. 16, the ordinate is labeled “Tr[RD1]_{Tr}” and the abscissa is labeled “Tr, min”. The upper graph in FIG. 16 shows the measured and calculated values of Tr[RD1]_{Tr} for a non-drifting biosensor response having a regression slope, m_{Tr}, equal to 0.347. The lower graph in FIG. 16 shows the measured and calculated values of Tr[RD1]_{Tr} for a drifting biosensor response having a regression slope, m_{Tr}, equal to 0.240.

The graphs in FIG. 16 illustrate that in determining when to apply a gain adjustment function, a threshold value of m_{Tr}, e.g. 0.300, may be chosen to determine that a gain adjustment beyond an induction period is necessary. The gain adjustment applies to all biosensor signal outputs beyond the induction period.

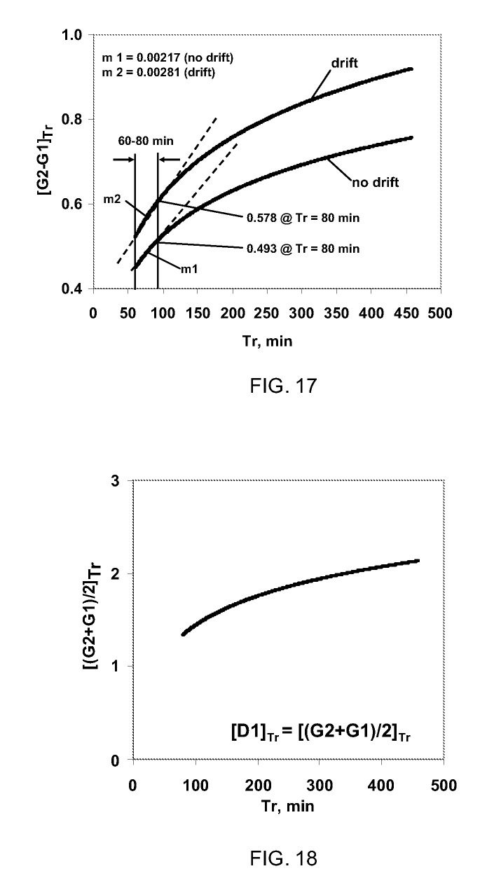

FIG. 17 shows graphs of the difference in the gain adjustment functions G2−G1 as a function of run-time, for drifting and non-drifting biosensor output responses. In FIG. 17, the ordinate is labeled “[G2−G1]_{Tr}” and, the abscissa is labeled “Tr, min”. The graphs in FIG. 17 show data delineated by vertical lines within a selected run-time range of 60-80 minutes within the baseline period.

The lower graph in FIG. 17, corresponds to a regression slope of m₁=0.00217 measured within a baseline period (e.g. 60-80 min) and the value of [G2−G1]_{Tr} at 80 minutes is labeled 0.493. The lower graph represents a non-drifting in vivo biosensor response. The upper graph in FIG. 17 corresponds to a regression slope of m₂=0.00281 measured within a baseline period (e.g. 60-80 min) and the value of [G2−G1]_{Tr} at 80 minutes is labeled 0.578. The upper graph represents a drifting in vivo biosensor response.

The slope of [G2−G1]_{Tr}, obtained from linear regression data within the 60-80 run-time range, within a baseline period, for a drifting biosensor (m₂=0.00281) is greater than for a non-drifting biosensor (m₁=0.00217). Setting a threshold limit for this slope value provides another means of distinguishing drifting from non-drifting in vivo biosensor responses. For example, if the threshold slope value was set at 0.00250, then slope values greater than 0.00250 would indicate biofouling. In FIG. 16, the slope of the [G2−G1]_{Tr} plot for the drifting sensor m₂=0.00281 is greater than the threshold value of 0.00250, therefore a gain adjustment is warranted.

Additionally shown in FIG. 17, are the point values of [G2−G1]_{Tr}, describing a non-linear, smooth curve for drifting versus non-drifting biosensor responses. The value of [G2−G1]_{Tr} at 80 minutes for the non-drifting biosensor is 0.493 whereas, the value of [G2−G1]_{Tr} at 80 minutes for the drifting biosensor is 0.578. If a threshold value was set at 0.550, the value of [G2−G1]₈₀ is greater than 0.550, therefore a drift adjustment is warranted.

### Drift Adjustment Functions

Drift adjustment functions [Dx]_{Tr} are derived from functions of both G1 and G2. Although a number of gain adjustment functions are possible, one example is discussed below.

Drift adjustment functions [Dx]_{Tr} are functions of both G1 and G2, indexed to run-time Tr. An example of such a function is the average of the gain adjustment functions G1 and G2 at each run-time point, denoted as:

[D1]_{Tr}=[(G1+G2)/2]_{Tr} for Tr>induction period (37)

FIG. 18 shows that [D1]_{Tr} is a non-linear function of run-time Tr. In the graph shown in FIG. 18, the ordinate is labeled “[(G1+G2)/2]_{Tr}” and is scaled in dimensionless multiple units of 1; and, the abscissa is labeled “Tr, min” and is scaled in units of 50 minutes. The graph is further labeled “[D1]_{Tr}=[(G1+G2)/2]_{Tr}”. As shown in the example below, the values of [D1]_{Tr} may be used to correct a drifting biosensor response current. In FIG. 18, the values of [D1]_{Tr} are plotted at a run-times greater than an induction period, e.g., Tr=80 min.

### EXAMPLE

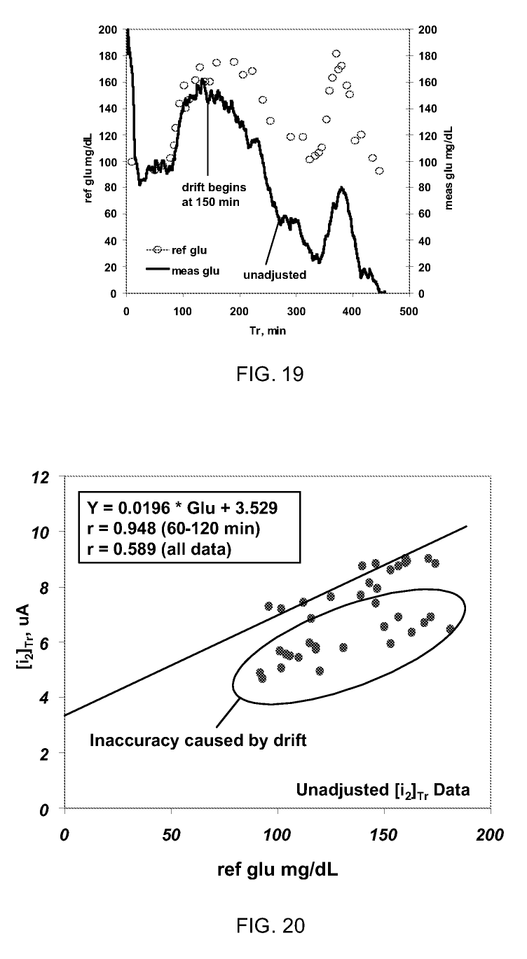

FIG. 19 shows a graph of unadjusted, calculated glucose values, measured by an in vivo, drifting amperometric GOx biosensor, as a function of run-time, plotted with a graph of reference glucose values, obtained by fingerstick measurements, as a function of run-time. The sensitivity and intercept, used in calculating glucose values in FIG. 19, were determined by linear regression of fingerstick reference glucose values against their corresponding run-time indexed biosensor output currents obtained within the baseline period.

In the graphs shown in FIG. 19:

(a) the left ordinate, reflecting reference glucose values, obtained by fingerstick measurements of blood samples from a subject wearing an intradermal, amperometric GOx biosensor is labeled “ref glu mg/dl” and is scaled in units of 20 mg/dl.

(b) the right ordinate reflecting unadjusted glucose values calculated from unadjusted biosensor output currents recorded from the same intradermal glucose biosensor is labeled “meas glu mg/dl’ and is scaled in units of 20 mg/dl, it is further labeled “unadjusted”;

(c) the common abscissa, reflecting run-time, is labeled “Tr, min” and is scaled in 100-minute units;

(d) the graph of reference glucose values, obtained by fingerstick measurements is identified by open circles; and,

(e) the graph of unadjusted, calculated glucose values, measured by an intradermal glucose biosensor is represented by the solid black, jagged line.

(f) the graph is further labeled “drift begins at 150 min” and “unadjusted”.

As shown in FIG. 19, after approximately 150 minutes, biofouling begins to cause a significant decrease in the accuracy of the calculated intradermal glucose values determined from calibration constants measured within the baseline period. The slope, m_{Tr}, in FIG. 12, was used as a guide in determining whether a drift adjustment due to biofouling was necessary. From examination of a number of in vivo data sets, the threshold value for slope m_{Tr} was set to 0.300±0.02. Under this scenario, values of m_{Tr} less than 0.300±0.02 were indicative of a drifting biosensor signal outputs. In the case of the measured glucose values shown in FIG. 19, the value of m_{Tr} as a function of run-time during the 60-80 minute time interval, within the baseline period, was 0.240, indicating a drift adjustment to the biosensing currents at run-times greater than 80 minutes was warranted.

FIG. 20 shows a graph of unadjusted biosensing response currents used to calculate the measured glucose responses in FIG. 18, plotted against the run-time indexed fingerstick reference glucose values for the drifting sensor response shown in FIG. 19. In FIG. 20:

(a) the graph is labeled in the box above by a linear equation: Y=0.0196*Glu+3.529; r=0.948 and r=0.589 (all data)”;

(b) the graph is labeled below as “Unadjusted [i₂]_{Tr} Data”;

(c) an elliptical circle is drawn around certain points and labeled “inaccuracy caused by drift”;

(d) the left ordinate, reflecting unadjusted biosensing current values [i₂]_{Tr} obtained from a drifting, in vivo biosensor, is labeled “[i₂]_{Tr}, μA” and is scaled in units of 1 μA;

(e) the abscissa, reflecting reference glucose values, is labeled reference glu mg/dL,” and is scaled in 25-mg/dL units.

The solid line in FIG. 20 was obtained by linear regression of the biosensing current values plotted against reference glucose values measured within a baseline period. The data below the regression line, in the elliptical circle labeled “inaccuracy caused by drift” are biosensing currents obtained at times greater than the induction period indexed to the times when fingerstick reference glucose measurements were made in the post induction period. FIG. 20 clearly shows the detrimental effect of biofouling on in vivo, amperometric, GOx biosensor response. The output current readings for corresponding reference glucose values measured after the induction period were uniformly less than expected from the regression line in FIG. 20.

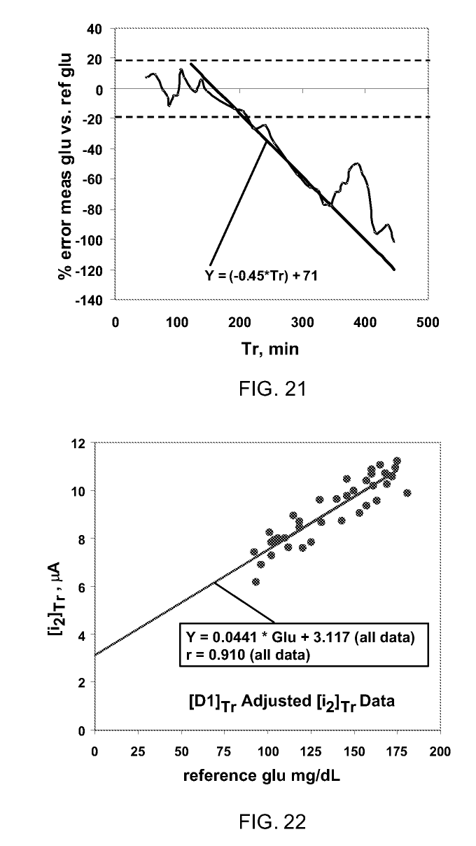

FIG. 21 shows a graph of the variation in the % error of the run-time indexed, measured glucose values versus run-time indexed, reference glucose values from FIG. 20. In FIG. 21, the ordinate is labeled “% error meas glu vs. ref glu” and the abscissa is labeled “Tr, min”. In FIG. 21, the calculated values of the error function were determined from linear regression of the measured error % versus run-time. The measured error is shown as a black, wavy line and a linear approximation of the error versus run-time is shown as a solid black, straight line labeled: “Y=(−0.45*Tr)+71”. FIG. 21 shows that beyond approximately 180 minutes, both the measured and calculated error exceeded −20% and toward the end of the run-time (450 min), the error in the response of the biosensor was approaching −100% versus fingerstick reference glucose measurements.

### Application of a Drift Adjustment Function to Drifting Biosensing Responses

To apply [D1]_{Tr}, the drifting, unadjusted biosensor response current at each run-time point greater than the induction period was multiplied by the corresponding [D1]_{Tr} value. The unadjusted, measured biosensing currents [i₂]_{Tr} in FIG. 10 were used to compute the measured glucose values in FIG. 19. The values of [i₂]_{Tr} were then used to produce adjusted biosensing currents {[i₂]_{Tr}}A from the application of [D1]_{Tr} to the [i₂]_{Tr} unadjusted current values, at run-times greater than the induction period, according to the following equation:

{[i₂]_{Tr}}_{A}=[D1]_{Tr}*[i₂]_{Tr} (38)

FIG. 22 shows a graph of the [D1]_{Tr} drift adjusted currents {[i₂]_{Tr}}A versus run-time indexed reference glucose values determined from blood samples taken from a subject wearing an intradermal GOx biosensor:

(a) the graph is labeled above by: “Y=0.0441*Glu+3.117; r=0.910 (all data)”;

(b) the graph is labeled below by “[D1]_{Tr} Adjusted [i₂]_{Tr} Data”;

(c) the left ordinate, reflecting drift adjusted biosensing current values obtained from equation 38, at run-times greater than an induction period, is labeled “{[i₂]_{Tr}}_{A}, uA” and is scaled in units of 2 μA.

The solid line in FIG. 22 was obtained by linear regression of the adjusted run-time indexed biosensing current values against run-time indexed reference glucose values determined after the baseline period. FIG. 22 clearly shows the improvement in the fit of the data versus the unadjusted data in FIG. 19.

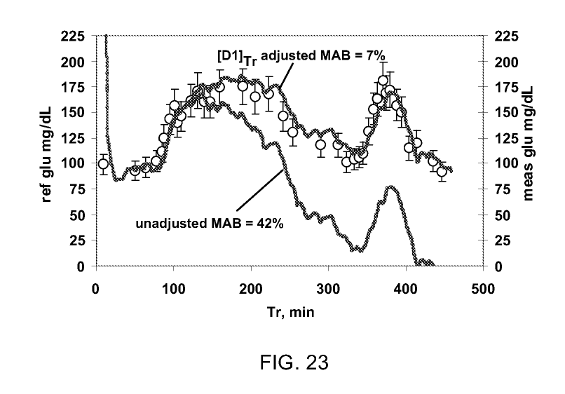

FIG. 23 shows the effect of the application of [D1]_{Tr} on the drifting biosensing currents [i₂]_{Tr} as reflected in glucose values computed from the adjusted biosensing currents, {[i₂]_{Tr}}A. FIG. 23, also shows there is a major improvement in the accuracy of the measured glucose values (MAB=7% for the adjusted data vs. an MAB value of 42% for the unadjusted data shown in FIG. 19 and FIG. 20.

In the graphs in FIG. 23:

(a) the left ordinate, reflecting reference glucose values, obtained by fingerstick measurements in mg per deciliter, is labeled “ref glu mg/dl” and is scaled in units of 25 mg/dl;

(b) the right ordinate reflecting both adjusted and unadjusted glucose values, measured by a drifting intradermal glucose biosensor in mg per deciliter, is labeled “meas glu mg/dl’ and is scaled in units of 25 mg/dl;

(c) the common abscissa, reflecting run-time, is labeled “Tr, min” and is scaled in 100-minute units;

(d) the graph of reference glucose values, obtained by fingerstick measurements is identified by open circles within vertical error bars of +/−10%;

(e) the lower graph of unadjusted glucose values, measured by a drifting intradermal glucose biosensor is represented by a solid gray jagged line and labeled “unadjusted MAB=42%”;

(f) the upper graph of adjusted, calculated glucose values, measured by the intradermal glucose biosensor is also represented by a solid black, jagged line and further labeled “[D1]_{Tr} adjusted MAB=7%”.

The Mean Absolute Bias Percent (MAB) is the average of all the values of the Absolute Bias Percent (AB %) calculated for each run-time indexed computed value of glucose versus the run-time indexed measured reference glucose value, where AB %=ABS{(meas−ref)/ref}*100, where the absolute value is denoted as ABS.

The improvement in the adjusted calculated glucose values in FIG. 23 versus the unadjusted glucose values is striking. FIG. 23 also shows that drift parameters obtained within the baseline period can be used to adjust for drifting biosensor response currents at run-times greater than the induction period without the need for recalibration.

### General Method for Application of Drift Adjustment Functions

### BG Processing System

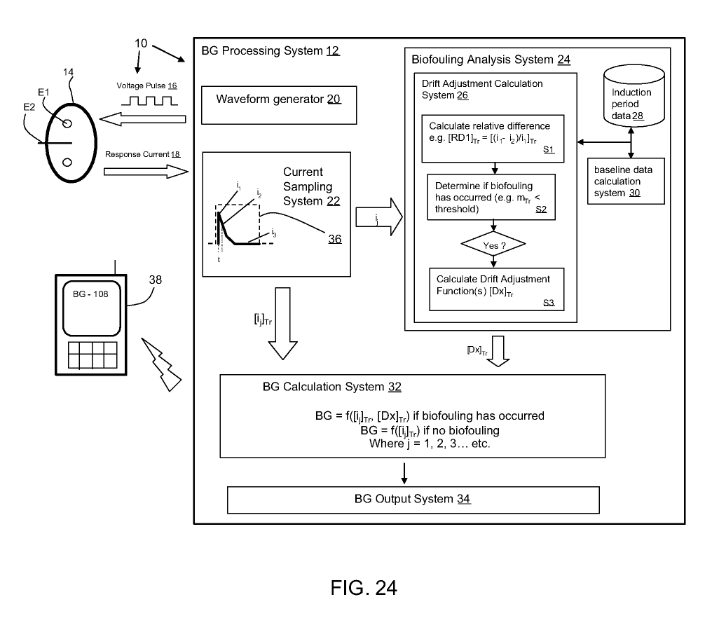

Referring now to FIG. 24, a system 10 for capturing continuous blood glucose (BG) readings is shown, which includes: a sensor 14, a BG processing system 12 and a display device 38. Sensor 14 includes a plurality of electrodes, e.g., E1, E2, E3, in which at least one electrode is placed beneath a subject's skin. In operation, sensor 14 receives a series of voltage pulses 16 from the BG processing system, and returns a response current 18, which is used by BG processing system to calculate a blood glucose reading. Voltage pulses 16 may be at any frequency, and comprise any shape (e.g., a square wave, etc).

BG processing system 12 includes: a potentiostat incorporating a waveform generator for generating and applying periodic or non-periodic voltage waveforms to the biosensor; a current sampling system 22 for sampling the response current 18 from application of the voltage waveforms; a biofouling analysis system 24 for determining if any biofouling is occurring and, if so, providing a drift adjustment; a BG calculation system 32 for calculating a BG reading; and a BG output system 34 for outputting the BG reading to the display device 38. BG processing system 12 can calculate a BG reading using currents generated from the application of any applied voltage waveform 16 (square waveform shown) as often as desirable. Moreover, some or all of BG processing system 12 may be integrated with the sensor 14 or reside apart from the sensor 14 (e.g., within display 38).

In response to a voltage pulse 36, a response current is sampled by current sampling system 22 at three or more transient time points tⱼ such as i₁, i₂, and i₃. Current values i₁, and i₂ are utilized by biofouling analysis system 24. Current values, i₁, i₂ or i₃ can be utilized by BG calculation system 32.

Biofouling analysis system 24 includes a drift adjustment calculation system 26 that determines if biofouling has occurred, and if so, calculates a drift adjustment [Dx]_{Tr}, where x=1, 2, 3 . . . and x values represent different gain functions. In addition, a calculation system 30 is provided along with induction period data 28 (e.g., collected during the first 30-60 minutes of use) to calculate biofouling threshold values, as well as, gains G1 and G2 used in the drift adjustment function [D1]_{Tr}.

As described herein, a relative difference [RD1] is computed at S1, e.g., using equation 30 where [RD1]_{Tr}=[(i₁−i₂)/i₁]_{Tr}. The regression slope, m_{Tr}, of a plot of Tr[RD1]_{Tr} versus Tr is determined within a baseline period (e.g. 60-80 min). The value of m_{Tr} is compared to a threshold limit at S2. If m_{Tr} is less than the threshold limit, a run-time indexed drift adjustment function [Dx]_{Tr} is calculated for use by BG calculation system 32. To obtain adjusted response values, each run-time indexed current function(s) is multiplied by the run-time indexed drift adjustment function [Dx]_{Tr} to yield a drift adjusted current function for each run-time point [Tr]ₙ.

As noted above, functions f of discrete sampled currents (e.g. i₁, i₂ or i₃) may be used to calculate the BG. If no biofouling has occurred then [Dx]_{Tr} is not used in the function f, and if biofouling has occurred then [Dx]_{Tr} is used within the function to compensate for biofouling. BG concentrations are calculated from the adjusted or unadjusted current functions using the sensitivity Sₖ or [S]_{Tr} and intercept bₖ. Note that a new BG reading can be provided at any time Tr, where a function of the response current is captured in response to the application of a voltage waveform 16.

Once the BG is calculated, it can be sent by BG output system 34 to an output device 38. Output device 38 may comprise any device capable of receiving and displaying data (e.g., an insulin pump, a cell phone, a Bluetooth device, a watch, etc.).

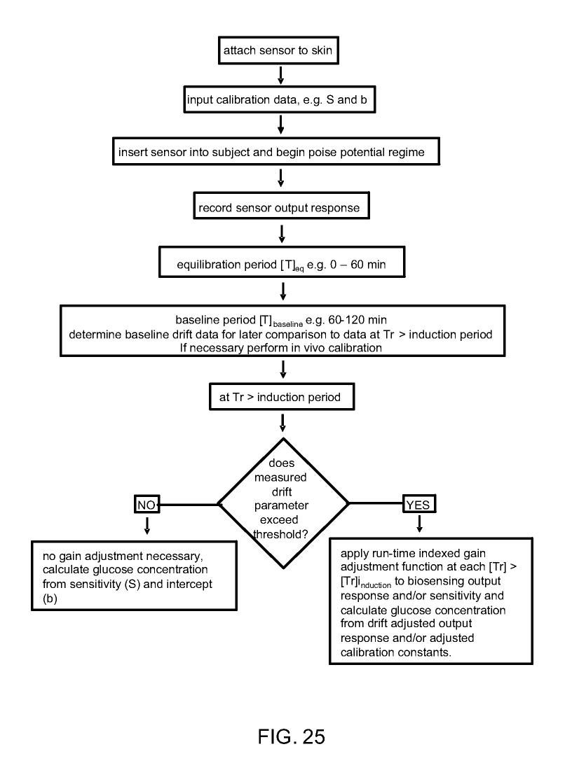

Referring to FIG. 25, the general steps to applying a biofouling gain adjustment to the biosensing current response are summarized as follows:

(a) The biosensor housing containing the biosensor working electrode and at least one other electrode is attached to the skin of a subject using an adhesive pad on the underside of the housing. The liner over the pad is removed and the biosensor housing pressed against the skin.

(c) The biosensor within the biosensor housing is activated by insertion into the subject, at which time, a potentiostat is triggered to begin an applied voltage regime.

(d) The applied voltage regime may consist of the application of a series of periodic voltage waveforms, such as a square wave voltage pulse between a counter and working electrode. The initial potential, prior to the first voltage step, may be zero volts with respect to the reference electrode; greater or less than zero volts with respect to the reference electrode; or, an open circuit potential E_{oc}. Either the entire current transient generated from the application of the square-wave voltage or a series of sampled transient currents are stored in the memory of the in vivo biosensor's microprocessor controlled monitoring unit.

(e) A period is required for the in vivo biosensor to equilibrate to its surroundings. An example of such an equilibrium period is 60-120 minutes from the time of implantation. Throughout the run-time period Tr, each application of a voltage waveform creates a characteristic current transient response. Within each transient, there are j values of current after the peak current iₚ. The maximum value of j is determined by the pulse width and the data sampling rate.

(f) Following the equilibration period, there is a period called the baseline period, within which, biofouling is assumed to be minimal. During this baseline period, an “in vivo” sensitivity may be determined by an in vitro reference glucose method using blood samples from the subject. For example, the baseline period may be 60-180 minutes in length; however, any range within that period (e.g. 60-80 min) may be used as the baseline collection period or calibration period.

(g) The data obtained within the baseline period is used to calculate a biofouling drift parameter which is compared to a software encoded threshold value to determine whether a drift adjustment is necessary at run-times greater than an induction period. Also, during the baseline period, other baseline parameters such as [E_{wc}]₀, [G_{Pw}]₀, [E_{wr}]₀, [Rₛ]₀ or [Rᵤ]₀ may be calculated. These baseline values may be compared, via relative difference functions, to calculated values of [E_{wc}]_{Tr}, [E_{wr}]_{Tr}, [G_{Pw}]_{Tr}, [Rₛ]_{Tr} or [Rᵤ]_{Tr} beyond the induction period. For example, if the drift determining parameter is outside a software encoded threshold limit, then gain adjustments are calculated and applied, on a point-by-point basis at run-times greater than an induction period, using gain adjustment functions such as [G_{Ewc}]_{Tr} (eq. 18); [G_{Rs}]_{Tr} (eq. 21); [G_{Pw}]_{Tr} (eq. 24); [G_{Ewr}]_{Tr} (eq. 27); or [D1]_{Tr} (eq. 37).

(h) If the calculated value of a drift parameter, e.g. m_{Tr}, is outside a threshold limit, then a gain adjustment function [Gx], encoded within the software of the monitoring unit, is used to calculate the value of the drift adjustment function [Dx]_{Tr} at each run-time point greater than an induction period;

(i) If the calculated value of the drift parameter is within the threshold range limit, no drift adjustment is necessary.

(j) If the drift parameter is outside the threshold limit, then point-by-point, run-time indexed, calculated values of the drift adjustment function are applied to each run-time indexed biosensing current function at run-times greater than a threshold period. Adjusting the biosensing current may require a similar adjustment in the sensitivity in order to compensate for changes in the magnitude of the biosensing current due to application of the drift adjustment function.

(k) Analyte concentrations at run-times greater than the induction period are calculated from the drift-adjusted values of the initial sensitivity S₀ and biosensing currents.

(l) If no drift is detected, analyte concentrations at run-times greater than the induction period are calculated from computer encoded calibration constants or from an adjusted calibration constants.

The foregoing description of the specific embodiments will so fully reveal the general nature of the invention that others can, by applying knowledge within the skill of the art (including the contents of the references cited herein), readily modify and/or adapt for various applications such specific embodiments, without undue experimentation, without departing from the general concept of the present invention.

While this invention has been described in connection with specific embodiments thereof, it will be understood that it is capable of further uses, variations modifications or adaptations. Such uses, variations, modifications and adaptations are intended to be within the meaning and range of equivalents of the disclosed embodiments, based on the teaching and guidance presented herein.

Having fully described this invention, it will be appreciated by those skilled in the art that the same can be performed, within a wide range of equivalent parameters, concentrations, and conditions without departing from the spirit and scope of the invention, and without undue experimentation. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one of ordinary skill in the art.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. No single feature, function, element or property of the disclosed embodiments is essential to all of the disclosed inventions. Similarly, where the claims recite “a” or “a first” element or the equivalent thereof, such claims should be understood to include incorporation of one or more such elements, neither requiring nor excluding two or more such elements.

The subject matter of the inventions includes all novel and non-obvious combinations and sub-combinations of the various elements, features, functions and/or properties disclosed herein. Inventions embodied in other combinations and sub-combinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

What is claimed is:

1. A system for capturing blood glucose readings, comprising:
a biosensor having two electrodes, wherein a first electrode can be disposed beneath a skin surface;
a waveform generator for generating and applying voltage waveforms across the two electrodes;
a sampling system for sampling biosensor output signals from the biosensor in response to an associated applied voltage waveform;
a biofouling analysis system that provides a drift adjustment function; and
a blood glucose calculation system that calculates a blood glucose concentration from the drift adjustment function and the biosensor output signal.

2. The system of claim 1, further comprising an observer sensor that assists in determining the drift adjustment function.

3. The system of claim 1, wherein values calculated from the drift adjustment function are proportional to an amount of biofouling.

4. The system of claim 1, wherein the biosensor output signals comprise a series of decaying current transients.

5. The system of claim 1, wherein the biofouling analysis system determines if biofouling has occurred by comparing a value of a relative difference function, computed within a baseline period, to a threshold value.

6. The system of claim 5, wherein at least one relative difference function is used to calculate gain adjustment functions.

7. The system of claim 6, wherein a calculated gain adjustment function is used to adjust drifting biosensor output signals.

8. The system of claim 1, wherein the waveforms comprise a series of square waves.

9. A computer program product stored on a computer readable medium, which when executed by a computer system, captures blood glucose readings, the computer program product comprising:
program code for generating and applying voltage waveforms across two electrodes of a biosensor, wherein a first electrode can be disposed beneath a skin surface;
program code for sampling biosensor output signals from the biosensor in response to an associated applied voltage waveform; and
program code for calculating a blood glucose concentration from a drift adjustment function and the biosensor output signal.

10. The program product of claim 9, wherein in the drift adjustment function is determined using an observer sensor.

11. The program product of claim 9, wherein values calculated from the drift adjustment function are proportional to an amount of biofouling.

12. The program product of claim 9, wherein the biosensor output signals comprise a series of decaying current transients.

13. The program product of claim 9, wherein the program code for calculating the blood glucose concentration determines if biofouling has occurred by comparing a value of a relative difference function, computed within a baseline period, to a threshold value.

14. The program product of claim 13, wherein at least one relative difference function is used to calculate a gain adjustment function.

15. The program product of claim 14, wherein a calculated gain adjustment function is used to adjust drifting biosensor output signals.

16. The program product of claim 9, wherein the waveforms comprise a series of square waves.

17. A method for adjusting drift of an in vivo biosensor's output signal comprising the steps of:
disposing a biosensor on the skin of a subject, wherein the biosensor includes at least two electrodes, one of which is implanted;
activating a biosensor on the skin of a subject by applying a voltage between two electrodes;
measuring an output signal from the biosensor;
determining whether the output signal is drifting and, if not drifting, computing an in vivo analyte concentration from the output signal and if drifting, computing the in vivo analyte concentration by applying a drift adjustment to the output signal.

18. The method of claim 17, wherein the output signal comprises a decaying transient.

19. The method of claim 17, wherein determining if drifting has occurred includes comparing a value of a relative difference function, computed within a baseline period, to a threshold value.

20. The method of claim 17, wherein the voltage applied between the two electrodes includes a series of pulses.
